(19) United States
(12) Patent Application Publication
(10) Pub. No.: US 2026/0186466 A1
(43) Pub. Date: Jul. 2, 2026

(54) POST PROCESSING MACHINE FOR 3D PRINTED OBJECTS

(71) Applicant: Imam Abdulrahman Bin Faisal University, Dammam (SA)

(72) Inventors: Maryam GHAZWI, Dammam (SA); Hala EL-WAKEEL, Dammam (SA); Zati HAZIRAT, Dammam (SA); Khadijah AL KHUWAITEM, Dammam (SA)

(73) Assignee: Imam Abdulrahman Bin Faisal University, Dammam (SA)

(21) Appl. No.: 19/006,920

(22) Filed: Dec. 31, 2024

(51) Int. Cl. G05B 19/042; B25J 9/16; B33Y 40/20; G06T 7/00

(52) U.S. Cl. CPC G05B 19/042; B25J 9/1697; B33Y 40/20; G06T 7/0004; G05B 2219/25257; G06T 2207/30144

(57) ABSTRACT

A post processing machine for 3D printed objects includes a housing having an inner chamber with a hermetically sealable door and a rotatable platform. A microcontroller controls a motor through a motion controller to rotate the platform, while coordinating multiple spray nozzles and a camera for surface treatment. The microcontroller executes a two-stage process: first smoothing surface of the object by coordinating solvent spray, water spray, and continuous image capture until matching a desired shape; then painting the object by selectively activating paint spray nozzles while monitoring progress through camera imaging until matching a desired painted image. A method implements this automated post-processing sequence through controlled material application and vision-based verification. A system integrates these capabilities with a remote computing device running specialized software for analyzing captured images, generating 3D meshes, and coordinating processing operations through wireless communication with the microcontroller.

### BACKGROUND

### TECHNICAL FIELD

The present disclosure is directed to additive manufacturing, and more particularly to a post-processing machine for finishing 3D printed objects through automated surface smoothing and painting operations.

### DESCRIPTION OF RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Additive manufacturing, commonly known as 3D printing, has revolutionized prototyping and small-scale production by enabling the creation of three-dimensional objects from digital models. This technology has become increasingly accessible to consumers and small businesses through the availability of consumer-grade 3D printers, particularly those utilizing Fused Deposition Modeling (FDM) technology. FDM enables creation of three-dimensional objects from digital models through layer-by-layer material deposition, facilitating production of objects for prototyping, small-scale production, and personal use. However, objects produced by 3D printing, particularly those made using FDM technology, typically exhibit surface imperfections such as visible layer lines, stair-stepping effects, and other irregularities inherent to the layered manufacturing process, affecting both the aesthetic appeal and functional properties of the printed objects. Therefore, these objects typically require post-processing operations to achieve desired surface quality and appearance. Additionally, many applications require specific surface finishes or colors that cannot be achieved through the printing process alone. Thus, although the manual shaping of prototypes has turned completely automated with 3D printing, the post-processing stage remains manual. This results in a varied level of end quality and a loss of time for the user.

Traditional post-processing methods for 3D printed objects primarily rely on manual techniques such as sanding, polishing, and painting. These manual processes are time-consuming, labor-intensive, and require considerable skill to achieve consistent results. The quality of the finished product often varies significantly based on the operator’s experience and attention to detail. Conventional post-processing methods for 3D printed objects can be broadly categorized into primary and secondary processing approaches. Primary post-processing methods, which focus on achieving desired surface characteristics, are further divided into subtractive and additive techniques. Subtractive methods include support removal, sanding (both dry and wet), sandblasting, acetone smoothing, polishing with mechanical tools, and tumbling operations. Additive primary processing methods encompass gap filling using putty or resin, primer application, and recycled plastic waste treatments. These primary processing steps are utilized for addressing common 3D printing artifacts such as layer lines, surface irregularities, and support material residue. Secondary post-processing methods primarily focus on enhancing the visual appearance and protective properties of the finished object. These methods predominantly utilize additive approaches including spray coating, brush coating, hydro dipping, dip coating, papercraft template application, laser and photochemical material treatments, and foiling. Traditional implementation of these post-processing methods typically requires manual intervention, leading to inconsistent results and significant time investment. The quality of the finished product often depends heavily on operator skill and experience, creating challenges for achieving repeatable, professional-quality results, particularly in consumer and small-scale production environments where automated solutions have been limited.

Some automated solutions have been proposed for post-processing 3D printed objects. These include tumbling systems for surface smoothing and separate painting systems. However, existing automated solutions typically address only one aspect of post-processing, requiring multiple separate machines and processes to achieve both surface smoothing and finishing. Furthermore, most of existing solutions are designed for industrial applications and are not suitable for consumer or small business use due to their size, complexity, and cost.

US20240091906A1 describes post-processing for additively manufactured objects using an agitatable drum to receive multiple objects and an applicator with a nozzle that directs thermally conductive particles toward the objects. In this system, a polymeric coating is applied at a later station on a conveyor belt, requiring separate processing steps and equipment. However, this reference does not perform post-processing on a 3D printed object which includes imaging the object and matching a 3D mesh of the image to a desired image stored in memory, nor does it include integrated spray nozzles for both surface smoothing and painting operations.

US20230391009A1 describes a multi-step post-processing system utilizing a cage-like meshed basket for object rotation, with separate mechanisms for bead-blasting and air ejection. The system includes a first stage where objects are placed in a meshed basket after cooling, followed by a second step of sand blasting and a third step where objects are immersed in dye. However, this reference does not perform post-processing on a 3D printed object which includes imaging the object and matching a 3D mesh of the image to a desired image stored in memory, nor does it include integrated spray nozzles for both surface smoothing and painting operations.

CN113910611B describes post-processing automation equipment incorporating a rotating support frame for workpiece placement and a spray mechanism for cleaning agent application. The support frame drives the printed workpiece to rotate, separating residues through centrifugal effect, while spray nozzles apply cleaning agents. However, this reference does not perform post-processing on a 3D printed object which includes imaging the object and matching a 3D mesh of the image to a desired image stored in memory, nor does it include integrated spray nozzles for both surface smoothing and painting operations.

Each of the aforementioned references suffers from one or more drawbacks hindering their practical implementation in consumer and small business environments, such as requiring multiple separate machines, lacking precision control for individual objects, and inability to provide real-time quality monitoring. These limitations result in inconsistent processing outcomes and increased operational complexity. Accordingly, it is one object of the present disclosure to provide an integrated post-processing machine that combines multiple finishing operations while incorporating automated quality control features in a format suitable for consumer-grade 3D printing applications.

### SUMMARY

In an exemplary embodiment, a post processing machine for 3D printed objects is described, comprising: a housing having an inner chamber and a hermetically sealable door; a rotatable platform located within the housing, wherein the rotatable platform is configured to hold a 3D printed object; a motor configured to rotate the rotatable platform; a motion controller configured to control the rotation of the motor; a plurality of spray nozzles; a camera directed to take images of the 3D printed object by scanning the 3D printed object; a microcontroller connected to the motor, the motion controller, a solvent pump, a water pump, a plurality of paint pumps and the camera, wherein the microcontroller includes electrical circuitry, a memory storing program instructions for post processing, a desired image shape and a desired painted image, and one or more processors configured to execute the program instructions to: perform a first post processing step which smooths a surface of the 3D printed object by a generation of first processing signals which actuate the solvent pump to spray solvent onto the 3D printed object while rotating the rotatable platform, actuate the water pump to spray water onto the 3D printed object, actuate the camera to take images of the 3D printed object, determine whether the images of the 3D printed object match a desired image shape stored in the memory of the microcontroller and the continuation of the first post processing step until the images of the 3D printed object match the desired image shape; and perform a second post processing step which paints the 3D printed object with a selected paint color while rotating the rotatable platform by a generation of second processing signals which include a selection of a spray nozzle, an actuation of the paint pump to spray paint from the spray nozzle of a desired color onto the 3D printed object, an actuation of the camera to take images of the painted 3D printed object, a matching of the images of the painted 3D printed object to a desired painted image stored in the memory of the microcontroller and a continuation of the second post processing step until the images of the 3D printed object match the desired painted image.

In another exemplary embodiment, a method for post processing a 3D printed object is described, comprising: placing a 3D printed object on a rotatable platform located within an inner chamber of a post processing machine; scanning, by a camera located within the inner chamber above the 3D printed object, the 3D printed object; determining during a first processing step which smooths a surface of the 3D printed object, by a microcontroller located within an electronics compartment and connected for receiving images from the camera, whether the images of the 3D printed object match a desired image shape stored in the memory of the microcontroller, when the images of the 3D printed object match the desired image shape, proceeding to a second processing step, when the images of the 3D printed object do not match the desired image shape, generating, by the microcontroller, first processing signals for actuating a solvent pump to spray solvent onto the 3D printed object while rotating the rotatable platform, actuating a water pump to spray water onto the 3D printed object, actuating the camera to take further images of the 3D printed object, determining whether the further images of the 3D printed object match the desired image shape and continuing the first post processing step until the images of the 3D printed object match the desired image shape; then determining during the second processing step for painting the 3D printed object with a selected paint color while rotating the rotatable platform, by generating, by the microcontroller, second processing signals which include selecting a spray nozzle, actuating a paint pump to spray paint from the spray nozzle of a desired color onto the 3D printed object, actuating the camera to take images of the painted 3D printed object, matching the images of the painted 3D printed object to a desired painted image stored in the memory of the microcontroller and a continuing the second post processing step until the images of the 3D printed object match the desired painted image.

In yet another exemplary embodiment, a system for operating a post processing machine to post process 3D printed objects is described, comprising: a housing having an inner chamber and a hermetically sealable door; a rotatable platform located within the housing, wherein the rotatable platform is configured to hold a 3D printed object; a motor configured to rotate the rotatable platform; a motion controller configured to control the rotation of the motor; a plurality of spray nozzles; a camera directed to take images of the 3D printed object by scanning the 3D printed object; a microcontroller connected to the motor, the motion controller, a solvent pump, a water pump, a plurality of paint pumps and the camera, wherein the microcontroller includes electrical circuitry, a memory storing program instructions for post processing, a desired image shape and a desired painted image, and one or more processors configured to execute the program instructions to: perform a first post processing step which smooths a surface of the 3D printed object by a generation of first processing signals which actuate the solvent pump to spray solvent onto the 3D printed object while rotating the rotatable platform, actuate the water pump to spray water onto the 3D printed object, actuate the camera to take images of the 3D printed object, determine whether the images of the 3D printed object match a desired image shape stored in the memory of the microcontroller and the continuation of the first post processing step until the images of the 3D printed object match the desired image shape; perform a second post processing step which paints the 3D printed object with a selected paint color while rotating the rotatable platform by a generation of second processing signals which include a selection of a spray nozzle, an actuation of the paint pump to spray paint from the spray nozzle of a desired color onto the 3D printed object, an actuation of the camera to take images of the painted 3D printed object, a matching of the images of the painted 3D printed object to a desired painted image stored in the memory of the microcontroller and a continuation of the second post processing step until the images of the 3D printed object match the desired painted image; and a post processing computer application stored on a remote computing device configured to receive the images of 3D printed object and the images of the images of the painted 3D printed object during the post processing, transform each of the images of 3D printed object and the images of the images of the painted 3D printed object to the 3D mesh, match the 3D mesh with a desired 3D image stored in the post processing computer application and transmit the 3D mesh to the wireless communication unit, wherein the wireless communication unit is configured to transmit the 3D mesh to the memory of the microcontroller.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is an exemplary front perspective diagram of a post-processing machine for 3D printed objects in an operational configuration thereof, according to certain embodiments.

FIG. 1B is an exemplary back perspective diagram of the post-processing machine disposed in the operational configuration thereof, according to certain embodiments.

FIG. 1C is an exemplary perspective diagram of the post-processing machine with its covers removed to show internal components thereof, according to certain embodiments.

FIG. 1D is an exemplary exploded diagram of the post-processing machine, according to certain embodiments.

FIG. 2 is an exemplary perspective diagram of a cylindrical chamber of the post-processing machine, according to certain embodiments.

FIG. 3 is an exemplary exploded diagram of a venting wall, disposed adjacent to a back wall, of the post-processing machine, according to certain embodiments.

FIG. 4A is an exemplary diagram of a crescent shaped nozzle band, holding a camera and a plurality of spray nozzles, of the post-processing machine, according to certain embodiments.

FIG. 4B is an illustration of the crescent shaped nozzle band in an upper position, according to certain embodiments.

FIG. 4C is an illustration of the crescent shaped nozzle band in a lowered position, according to certain embodiments.

FIG. 4D is an illustration of the ball joint mechanism, according to certain embodiments.

FIG. 4E is an illustration of the ball joint mechanism retracted to permit the spray nozzle to tilt, according to certain embodiments.

FIG. 4F is an illustration of the ball joint mechanism moving to a right end of the crescent shaped nozzle band, according to certain embodiments.

FIG. 4G is an illustration of the ball joint mechanism moving to a left end of the crescent shaped nozzle band, according to certain embodiments.

FIG. 4H is an illustration of a belt connector which holds the ball joint mechanism to the crescent shaped nozzle band, according to certain embodiments.

FIG. 5 is an exemplary schematic diagram of a material supply unit of the post-processing machine, according to certain embodiments.

FIG. 6 is an exemplary partial perspective diagram of the post-processing machine illustrating a display, providing a button interface, therein, according to certain embodiments.

FIG. 7 is an exemplary partial exploded diagram of a first compartment of the post-processing machine, according to certain embodiments.

FIG. 8 is an exemplary diagram of a bottom part of an inner mechanism, showing details of an excess material holder, of the post-processing machine, according to certain embodiments.

FIG. 9A is an exemplary partial perspective diagram of the post-processing machine with a finishing tool integrated therewith, according to certain embodiments.

FIG. 9B is an exemplary illustration of usage of the finishing tool of the post-processing machine, according to certain embodiments.

FIG. 10 is an exemplary perspective diagram of the post-processing machine in a collapsed configuration thereof, according to certain embodiments.

FIG. 11 is an exemplary schematic diagram of a system for operating the post processing machine to post process 3D printed objects, according to certain embodiments.

FIG. 12 is an exemplary flowchart of a method for post processing a 3D printed object, according to certain embodiments.

FIG. 13 is an illustration of a non-limiting example of details of computing hardware used in a microcontroller of the post processing machine and/or a remote computing device of the system, according to certain embodiments.

FIG. 14 is an exemplary schematic diagram of a data processing system used within the microcontroller and/or remote computing device, according to certain embodiments.

FIG. 15 is an exemplary schematic diagram of a processor used with the microcontroller and/or remote computing device, according to certain embodiments.

FIG. 16 is an illustration of a non-limiting example of distributed components which may share processing with the computing hardware, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to a post-processing machine for 3D printed objects, a method for post processing a 3D printed object, and a system for operating a post processing machine to post process 3D printed objects. The post processing machine of the present disclosure integrates both surface smoothing and painting capabilities, providing both primary and secondary post-processing operations, in a single automated system. The post-processing machine incorporates coordinated mechanical systems, fluid delivery mechanisms, and computer vision capabilities to provide consistent and repeatable post-processing results for 3D printed objects. The automated nature of the system significantly reduces processing time compared to manual methods while ensuring consistent, high-quality results across multiple objects.

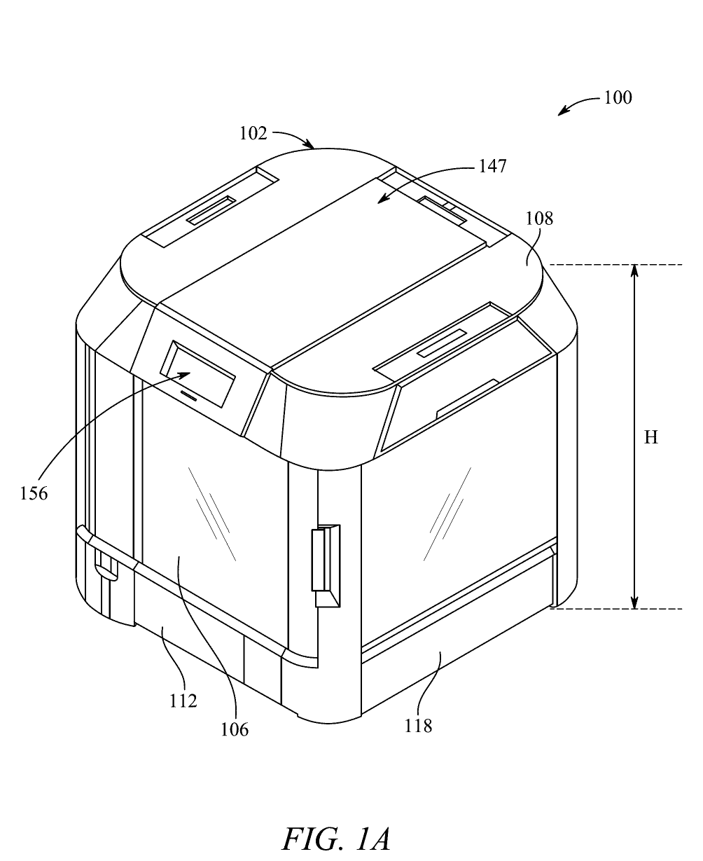

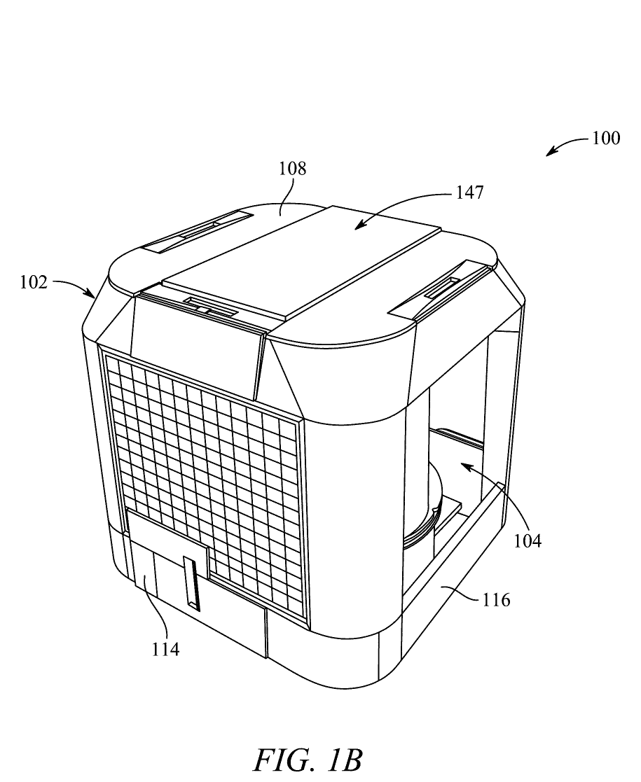

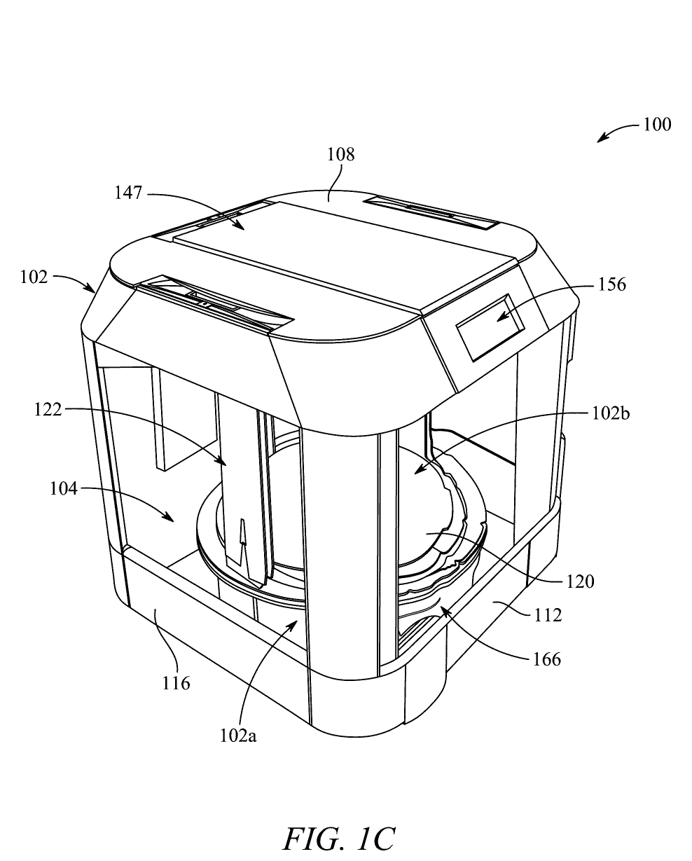

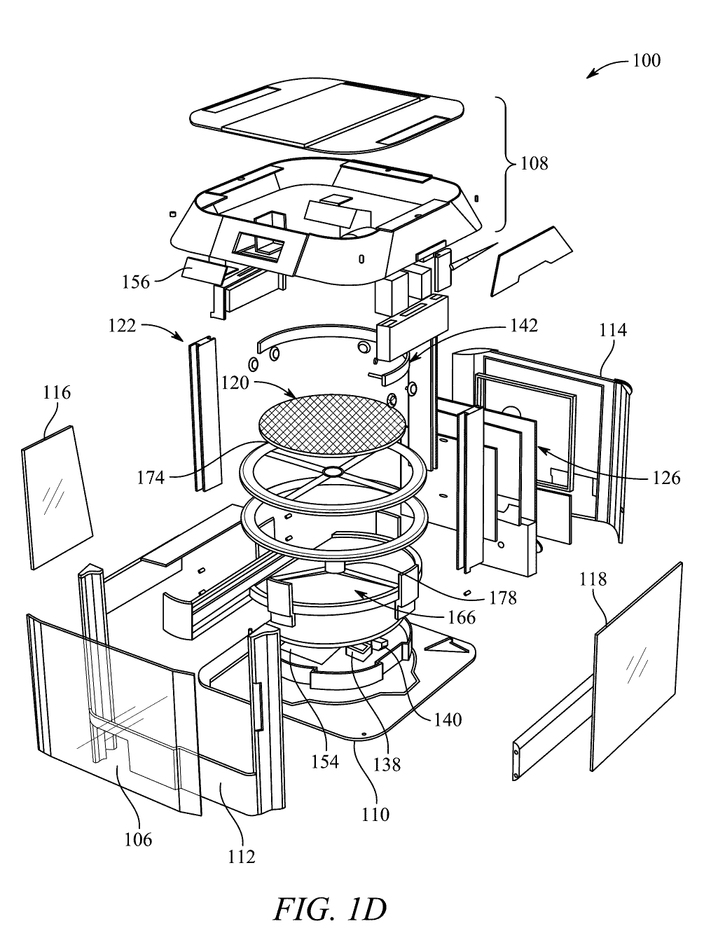

Referring to FIGS. 1A - 1D in combination, illustrated are various views of a post processing machine (as represented by reference numeral 100) for 3D printed objects. Herein, FIG. 1A illustrates a front perspective diagram of a post-processing machine 100 in an operational configuration thereof; FIG. 1B illustrates a back perspective diagram of the post-processing machine 100; FIG. 1C illustrates a perspective diagram of the post-processing machine 100 showing internal components thereof; and FIG. 1D illustrates an exploded diagram of the post-processing machine 100. The post processing machine 100 of the present disclosure provides automated surface finishing and painting capabilities for objects produced through 3D printing processes. The post processing machine 100 integrates multiple processing stages within a controlled environment to transform raw 3D printed objects into finished products with smooth surfaces and precise color applications, while minimizing operator intervention. The post processing machine 100 incorporates control systems that continuously monitor and adjust processing operations based on real-time analysis of object characteristics. The post-processing machine 100 of the present disclosure is further designed to facilitate easy assembly and maintenance, for convenience of the operator.

As illustrated, the post processing machine 100 includes a housing 102 having an inner chamber 104 (better shown in FIG. 1C) and a hermetically sealable door 106. The housing 102 is constructed to provide a controlled environment for post-processing operations on 3D printed objects. The housing 102 includes multiple interconnected panels forming an enclosure. Specifically, the housing 102 includes a top cover 108, a bottom cover 110, a front wall 112, a back wall 114, a first side wall 116, and a second side wall 118 opposite to the first side wall 116. Herein, the top cover 108 defines an upper boundary of the housing 102, the bottom cover 110 defines a lower boundary of the housing 102, the front wall 112 defines a forward facing surface of the housing 102, the back wall 114 defines a rear facing surface of the housing 102 opposite to the front wall 112, the first side wall 116 defines a first lateral surface of the housing 102, and the second side wall 118 defines a second lateral surface of the housing 102 opposite to the first side wall 116. In an example configuration, the first side wall 116 and the second side wall 118 may be in the form of clear glass to provide transparent structure, to facilitate user to monitor processing operations inside the housing 102.

The hermetically sealable door 106 is located in the front wall 112 and provides access to the inner chamber 104. Herein, the hermetically sealable door 106 is positioned within and integrated into the front wall 112. The hermetically sealable door 106 is configured to provide selective access to the inner chamber 104 while maintaining the controlled environment when sealed. The term “hermetically sealable” as used herein refers to an air-tight seal that prevents exchange of air, moisture, and contaminants between the inner chamber 104 and the external environment when the door 106 is in a closed position. The hermetically sealable door 106 may include sealing components around its perimeter that engage with corresponding surfaces of the front wall 112 to create and maintain the hermetic seal when it is closed. The positioning of the hermetically sealable door 106 in the front wall 112 enables convenient access to place and remove 3D printed objects from the inner chamber 104 while maintaining the integrity of the controlled processing environment when sealed.

The post processing machine 100 further includes a rotatable platform 120 located within the housing 102. The rotatable platform 120 is parallel to the bottom cover 110. The rotatable platform 120 is disposed horizontally within the housing 102, oriented parallel to the bottom cover 110. The rotatable platform 120 is configured to hold the 3D printed object. The rotatable platform 120 provides a circular base structure and has a planar surface to support and secure the 3D printed object during post processing operations. The dimensions and proportions of the housing 102 are selected to accommodate 3D printed objects of sizes typically produced by consumer-grade 3D printers, while maintaining a form factor suitable for desktop or workbench placement. Herein, the interior space of the housing 102 is partitioned into two compartments by the rotatable platform 120. The housing 102 includes a first compartment 102a located between the bottom cover 110 and the rotatable platform 120, and a second compartment 102b located between the rotatable platform 120 and the top cover 108. The first compartment 102a is configured to house various mechanical and electrical components of the post processing machine 100. Further, the second compartment 102b is designed to provide the primary processing space where post processing operations are performed on 3D printed objects placed on the rotatable platform 120.

In an example configuration, a distance between the top cover 108 and the bottom cover 110 is equal to a height H. That is, the housing 102 is dimensioned such that a vertical distance between the top cover 108 and the bottom cover 110 defines the height ‘H’. The first compartment 102a is defined in a lower portion of the housing 102, extending vertically from the bottom cover 110 to the rotatable platform 120. In the present configuration, a distance from the bottom cover 110 to the rotatable platform 120 is about H/5. That is, the first compartment 102a occupies approximately one-fifth of the total height H of the housing 102, specifically having the vertical dimension of about H/5 measured from the bottom cover 110 to the underside of the rotatable platform 120. The second compartment 102b is defined in an upper portion of the housing 102, extending vertically from the rotatable platform 120 to the top cover 108. A distance from the rotatable platform 120 to the top cover 108 is about 4H/5. That is, the second compartment 102b occupies approximately four-fifths of the total height H of the housing 102, specifically having the vertical dimension of about 4H/5 measured from the upper surface of the rotatable platform 120 to the top cover 108.

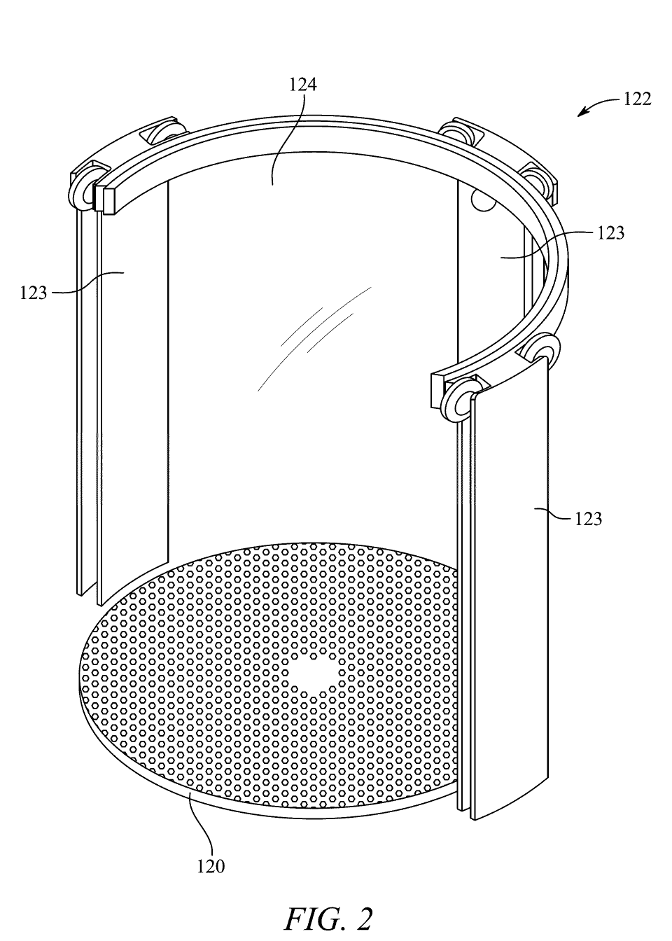

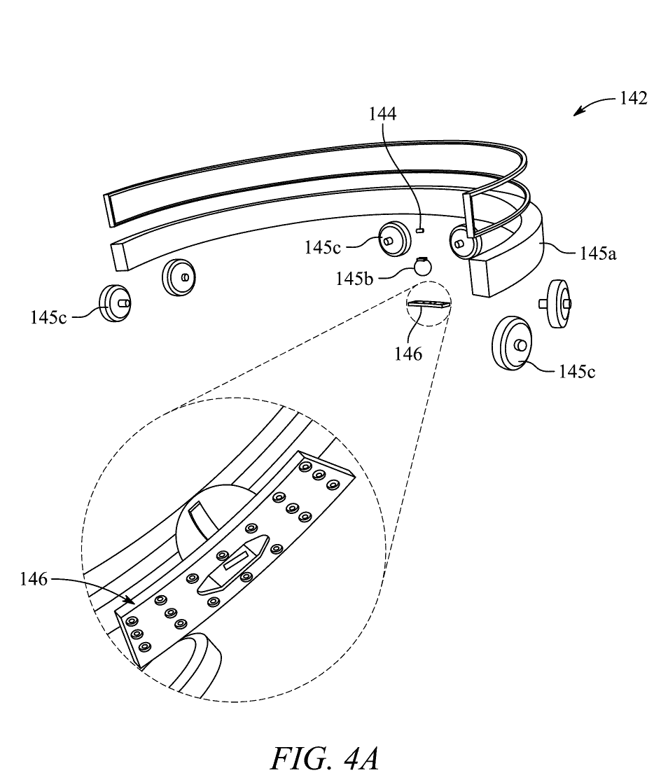

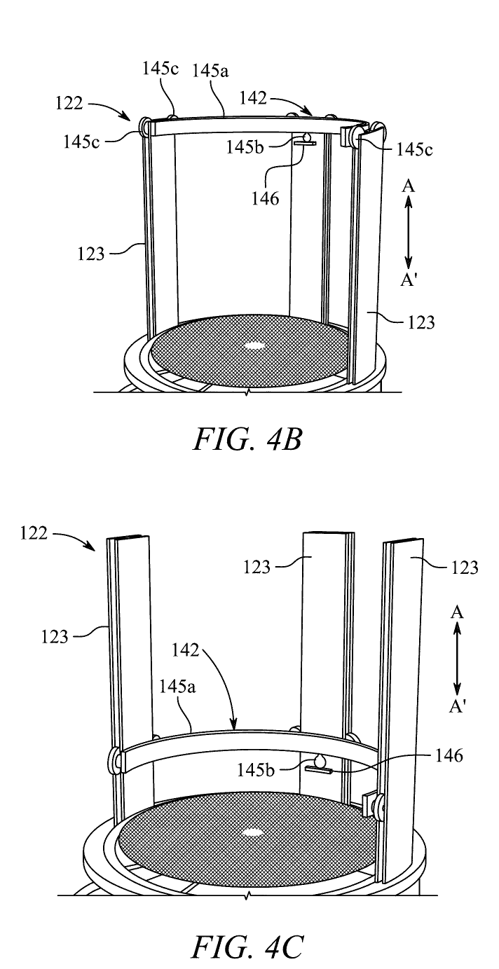

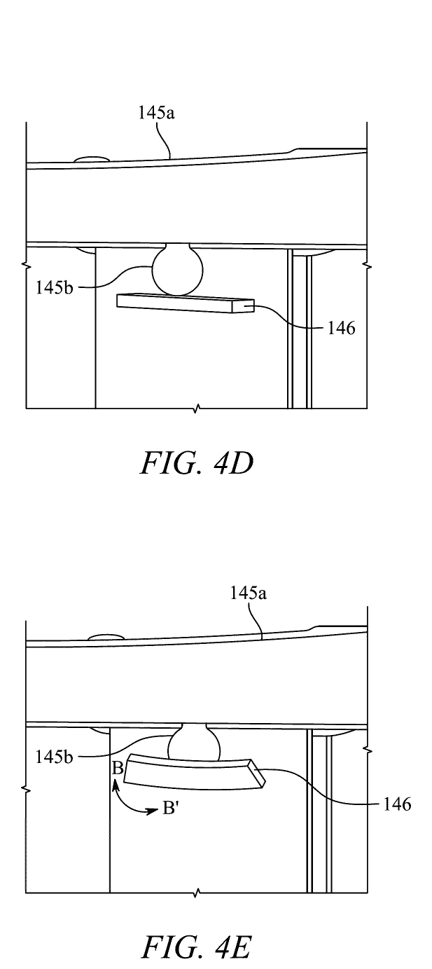

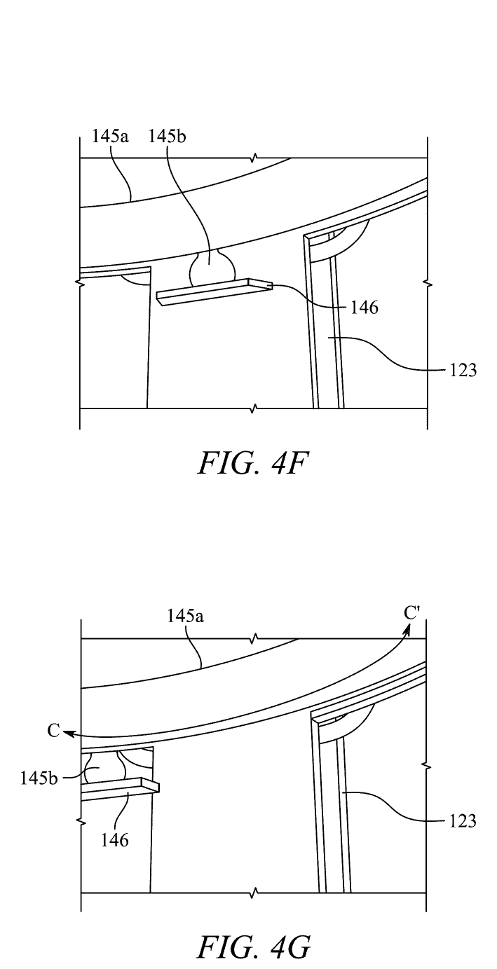

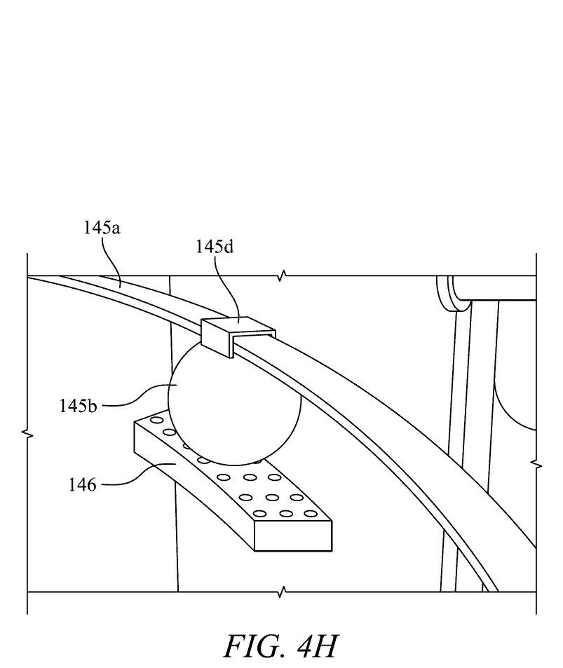

The post processing machine 100 further includes a cylindrical chamber 122 located within the second compartment 102b. FIG. 2 illustrates a perspective diagram of the cylindrical chamber 122 of the post-processing machine 100. The cylindrical chamber 122 is configured as a processing enclosure having a generally circular cross-section. The cylindrical chamber 122 is oriented such that a central length axis of the cylindrical chamber 122 is concentric with a central length axis of the rectangular housing 102, providing symmetrical positioning of processing components around the rotatable platform 120. The cylindrical chamber 122 includes a semicircular wall 124 that forms approximately half of the cylindrical circumference. Three supports 123 are shown, which include tracks for the wheels which move the crescent shaped nozzle band 142 up and down, as shown in FIG. 4B and 4C. The semicircular wall 124 is positioned such that its straight edges extend from the back wall 114 toward the front of the housing 102. The semicircular wall 124 is disposed adjacent to the back wall 114 and extends laterally such that its outer edges are partially adjacent to the first side wall 116 and the second side wall 118. This configuration of the semicircular wall 124 creates a curved processing surface that partially surrounds the processing area while maintaining accessibility from the front of the post processing machine 100 through the hermetically sealable door 106. Further, the curved geometry of the semicircular wall 124 facilitates uniform distribution of processing materials onto 3D printed objects placed on the rotatable platform 120.

Referring back to FIGS. 1A - 1D in combination, as illustrated, the post processing machine 100 further includes a venting wall 126. The venting wall 126 is positioned adjacent and parallel to the back wall 114 within the housing 102. The venting wall 126 is configured with mounting structures and passages to support and direct airflow through a multi-stage air filtration and ventilation system for processing exhaust air generated during post processing operations.

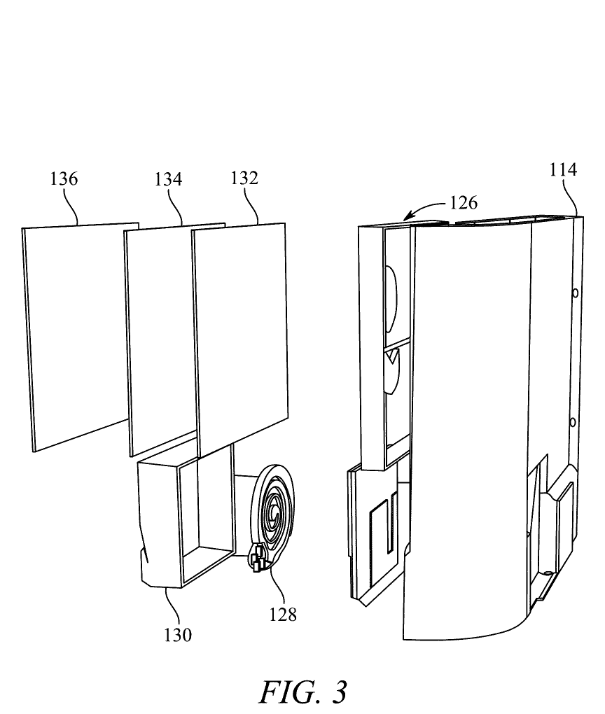

FIG. 3 illustrates the venting wall 126 in relation to the back wall 114, along with other related components. As illustrated, a fan 128 is mounted adjacent to the venting wall 126. The fan 128 includes a frame 130. Specifically, as may be understood from FIG. 3, the fan 128 is housed within the frame 130. The fan 128 is electrically connected to receive control signals for regulated operation during processing. The fan 128 generates controlled airflow to extract fumes, vapors, and particulates from the inner chamber 104 and direct them through the filtration system.

Further, as illustrated, the frame 130 is configured with channels and mounting features to secure a filtration system having multiple filter elements in a stacked arrangement. In particular, the filtration system includes three filter elements arranged sequentially within the frame 130. A HEPA filter 132 (High-Efficiency Particulate Air filter) is located within the frame 130 adjacent to the fan 128. The HEPA filter 132 is configured to remove fine particles, generally, down to 0.3 microns in size with 99.97% efficiency. Further, a carbon filter 134 is located within the frame 130 adjacent to the HEPA filter 132. The carbon filter 134 is configured to adsorb volatile organic compounds, solvents, and other chemical vapors generated during processing operations. Furthermore, a prefilter 136 is located within the frame 130 adjacent to the carbon filter 134. The prefilter 136 is configured as the first stage of filtration to capture larger particulates and extend the operational life of the HEPA and carbon filters. The frame 130 may incorporate sealing elements between each filter element 132, 134, 136 and at its interface with the venting wall 126 to ensure all exhaust air passes sequentially through each filtration stage before being released. The frame 130 is designed to allow access for replacement of individual filter elements 132, 134, 136 as needed while maintaining the integrity of the filtration system during operation.

Referring back to FIGS. 1A - 1D in combination, as illustrated, the post processing machine 100 further includes a motor 138 mechanically coupled to the rotatable platform 120. The motor 138 is positioned within the first compartment 102a beneath the rotatable platform 120. The post processing machine 100 further includes a motion controller 140 configured to control the rotation of the motor 138. Specifically, the motion controller 140 is configured to control a speed of the motor 138. The motion controller 140 is electrically coupled to the motor 138 to regulate and control the rotational movement of the motor 138. The motion controller 140 is also positioned within the first compartment 102a and is configured to receive digital control signals and generate corresponding electrical drive signals to operate the motor 138. The motion controller 140 precisely controls operational parameters of the motor 138 including rotational speed and acceleration/deceleration. The motor 138 and the motion controller 140 work in conjunction to provide precise rotational control to rotate the rotatable platform 120 with a 3D printed object mounted thereon, ensuring programmed movement sequences coordinated with other processing operations.

In an aspect of the present disclosure, the motor 138 includes a stator (not shown) connected to the bottom cover 110. The stator component is fixedly mounted to the bottom cover 110. Herein, the stator is configured with a core. That is, the stator incorporates a core structure, within which other components may be supported. The motor 138 further includes a rotor (not shown) located within the core. That is, the rotor component is positioned within the core of the stator. The rotor is mechanically coupled to the rotatable platform 120 through a shaft extending vertically from the rotor to engage with a central opening in the rotatable platform 120. Herein, the rotor is configured to rotate the rotatable platform 120. The mechanical coupling between the rotor and the rotatable platform 120 enables transfer of rotational motion from the motor 138 to the rotatable platform 120. When the rotor is actuated to rotate within the core of the stator, the rotational motion is transmitted through the shaft to rotate the rotatable platform 120 about its central axis. A person having ordinary skill in the art may contemplate such arrangement and will appreciate that alternative motor configurations may be employed while maintaining similar functionality. The specific implementation may be selected based on factors such as required torque, speed control precision, cost considerations, and space constraints within the first compartment 102a.

Further, as illustrated in FIG. 4A, the post processing machine 100 includes a crescent shaped nozzle band 142. The crescent shaped nozzle band 142 is located on an inner surface of the cylindrical chamber 122. The crescent shaped nozzle band 142 is mounted to follow the curved geometry of the semicircular wall 124 of the cylindrical chamber 122, providing a mounting structure that partially encircles the processing area above the rotatable platform 120. FIGS. 4A - 4H in combination illustrate the crescent shaped nozzle band 142 showing details of components supported thereby. As illustrated, the crescent shaped nozzle band 142 is configured to hold a camera 144 and a plurality of spray nozzles 146. The crescent shaped nozzle band 142 includes mounting points and supply line connections for the camera 144 and the spray nozzles 146.

Herein, the camera 144 is directed to take images of the 3D printed object by scanning the 3D printed object. The camera 144 is mounted on the crescent shaped nozzle band 142 at a position optimized for capturing detailed images of objects on the rotatable platform 120. As the rotatable platform 120 rotates, the camera 144 captures multiple images from different angles, enabling complete scanning of the entire surface of the 3D printed object. These images are used for monitoring and controlling the post processing operations to achieve desired surface characteristics. The plurality of spray nozzles 146 are disposed at predetermined intervals along the crescent shaped nozzle band 142. Each spray nozzle 146 is configured to selectively dispense processing materials onto a 3D printed object positioned on the rotatable platform 120. The arrangement of the spray nozzles 146 along the curved path of the crescent shaped nozzle band 142 enables uniform coverage of the 3D printed object during processing operations. The positioning of the camera 144 and spray nozzles 146 on the crescent shaped nozzle band 142 facilitates coordinated operation between imaging and material application. This arrangement enables real-time monitoring of surface treatment progress while ensuring uniform coverage during post-processing operations.

As shown in FIGS. 4B - 4C, 4H, the crescent shaped nozzle band 142 may incorporate additional mechanical components that enable precise positioning and movement of the spray nozzles 146 and the camera 144. The crescent shaped nozzle band 142 includes a movement system that enables positioning and control of the spray nozzles 146. A belt 145a extends along the length of the crescent shaped nozzle band 142. The belt 145a is supported by wheels 145c positioned at regular intervals, which engage with grooves formed in vertical members of the cylindrical chamber 122. The wheels 145c are powered by stepper motor controlled by stepper motor drivers under the control of the microcontroller 154. The spray nozzles 146 are mounted to the crescent shaped nozzle band 142 through a ball joint mechanism 145b. A belt connector 145d secures the ball joint mechanism 145b to the belt 145a. The wheels 145c provide guided movement of the belt 145a along axis A-A'. The ball joint mechanism 145b enables rotation about axis B-B', allowing the spray nozzles 146 to be oriented at various angles relative to the target surface. As shown in FIG. 4G, the belt connector 145d facilitates the ball joint mechanism 145b to traverse horizontally along axis C-C'.

As may be seen in FIG. 4D, 4E and 4F, the crescent shaped nozzle band 142 may include the belt mechanism mounted along its length and guided by wheels positioned at intervals. Each spray nozzle 146 is mounted to the crescent shaped nozzle band 142 through a ball joint mechanism 145b that enables multi-directional adjustment of the nozzle orientation. The ball joint mechanism 145b has a rectangularly shaped slot with a gap beneath it which engages with a tab on the spray nozzle 146 and an internal motor which rotates the ball joint mechanism 145b upward as needed to direct the spray nozzle 146. The integrated belt, wheels, and ball joint mechanisms work together to provide stable support for the spray nozzles 146 and the camera 144 while enabling precise control of material application trajectories.

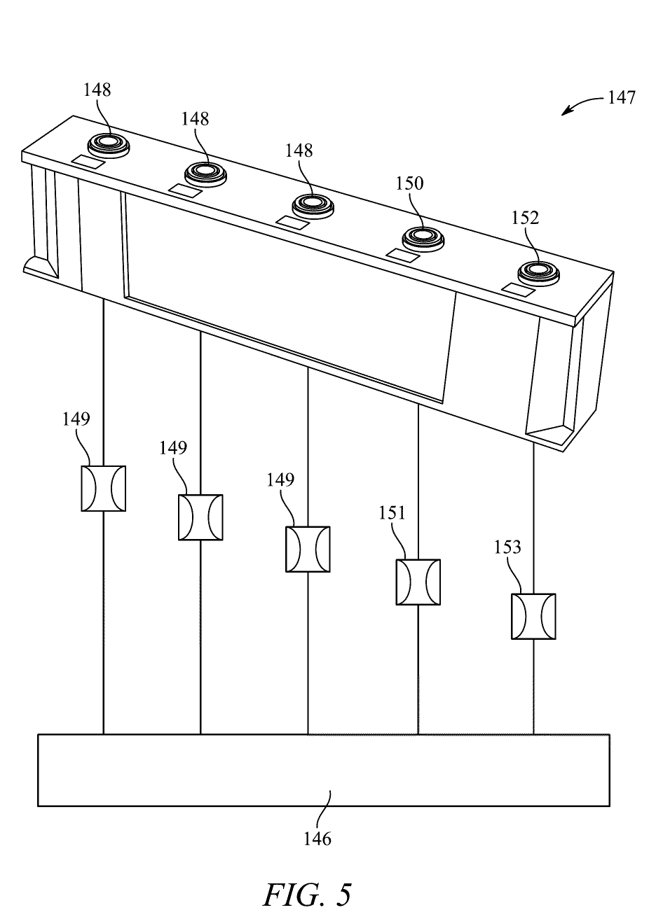

Referring back to FIGS. 1A - 1D in combination, as illustrated, the post processing machine 100 further includes a material supply unit 147. The material supply unit 147 is mounted on or supported within the top cover 108 of the housing 102. The material supply unit 147 is configured to supply required fluids to the plurality of spray nozzles 146 for performing the post-processing operations. FIG. 5 illustrates a schematic diagram of the material supply unit 147. As illustrated, the material supply unit 147 includes a plurality of paint cartridges 148. Herein, each paint cartridge 148 includes a corresponding paint pump 149 connected by tubing to a dedicated one of the spray nozzles of the plurality of spray nozzles 146. Each paint cartridge 148 is configured as a self-contained unit incorporating a reservoir for storing paint and an integrated pump mechanism. The paint cartridges 148 are removably mounted within the material supply unit 147 to facilitate replacement or refilling. Dedicated tubes connect each paint cartridge 148 to its corresponding spray nozzle 146, ensuring separate pathways for different paint colors and preventing cross-contamination. In an example, the paint colors may be formed as PVA (Polyvinyl Alcohol) aerosols. It may be appreciated that when a surface of the 3D printed object is sprayed with the paint, the color mixing is performed on the object itself.

The post processing machine 100 further includes a solvent tank 150, which may also be incorporated in the material supply unit 147 (as shown in FIG. 5). Herein, the solvent tank 150 is connected by a solvent pump 151 to the plurality of spray nozzles 146 of the crescent shaped nozzle band 142. The solvent tank 150 is configured to store and supply a solvent to the plurality of spray nozzles 146. The solvent pump 151 is configured to precisely control the flow of the solvent from the solvent tank 150 through fluid lines to the spray nozzles 146 during surface smoothing operations. In an aspect, the solvent is ethyl acetate. Ethyl acetate is specifically selected as the solvent due to its effectiveness in smoothing the surface of 3D printed objects while being compatible with common 3D printing materials. The post processing machine 100 further includes a water tank 152, which may also be incorporated in the material supply unit 147 (as shown in FIG. 5). Herein, the water tank 152 is connected by a water pump 153 to the plurality of spray nozzles 146 of the crescent shaped nozzle band 142. The water tank 152 stores clean water used for rinsing operations following solvent application. The water pump 153 controls the delivery of water from the water tank 152 through dedicated fluid lines to the spray nozzles 146. The water spray, from the spray nozzles 146, removes excess solvent and clean the surface of the 3D printed object during processing operations.

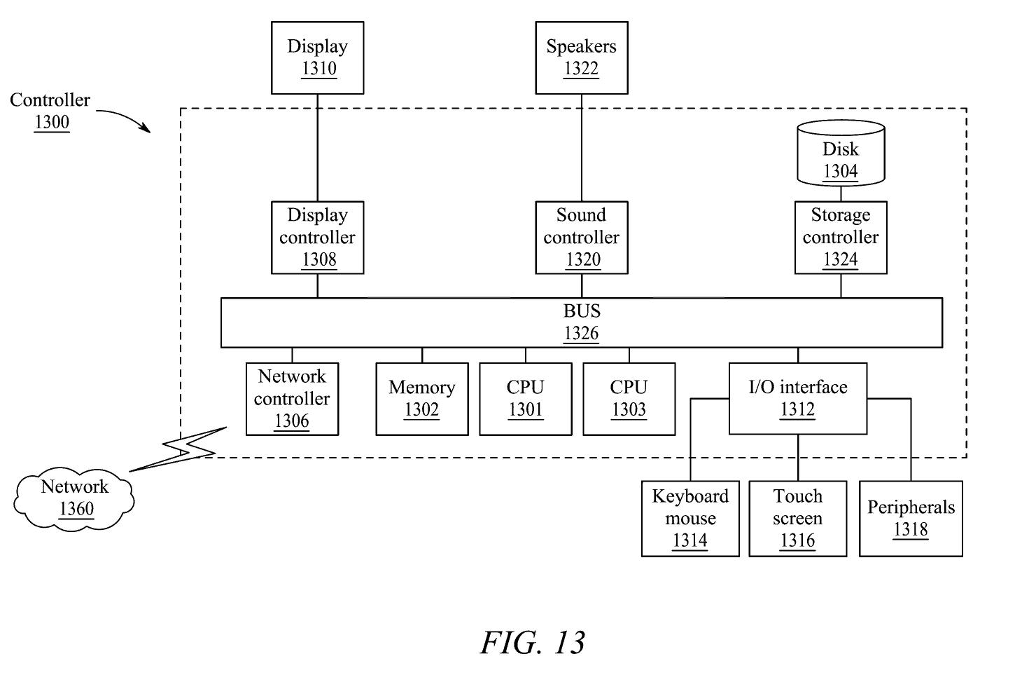

Referring back to FIGS. 1A - 1D in combination, as illustrated, the post processing machine 100 further includes a microcontroller 154 positioned within the first compartment 102a. The microcontroller 154 serves as the central control unit for coordinating all operational aspects of the post processing machine 100, with its hardware and software configuration discussed in detail later in reference to FIGS. 13 - 16. The microcontroller 154 is connected to the motor 138, the motion controller 140, the solvent pump 151, the water pump 153, the plurality of paint pumps 149 and the camera 144. This interconnected configuration enables the microcontroller 154 to coordinate and synchronize multiple processing operations. Specifically, the microcontroller 154 manages rotational control of the rotatable platform 120 through signals to the motion controller 140 which operates the motor 138, delivery of processing fluids through controlled operation of the solvent pump 151, the water pump 153, and the paint pumps 149, and image capture operations of the camera 144. The microcontroller 154 includes electrical circuitry configured to generate appropriate control signals for each connected component. The electrical circuitry includes analog and digital interfaces for sending control signals to the various pumps 149, 151, 153, receiving feedback signals from sensors, controlling the motion controller 140, and managing data transfer from the camera 144. The connections between the microcontroller 154 and the controlled components are implemented through electrical interfaces and wiring routed within the housing 102. This integrated control architecture facilitates synchronization of various operations to achieve desired post processing results.

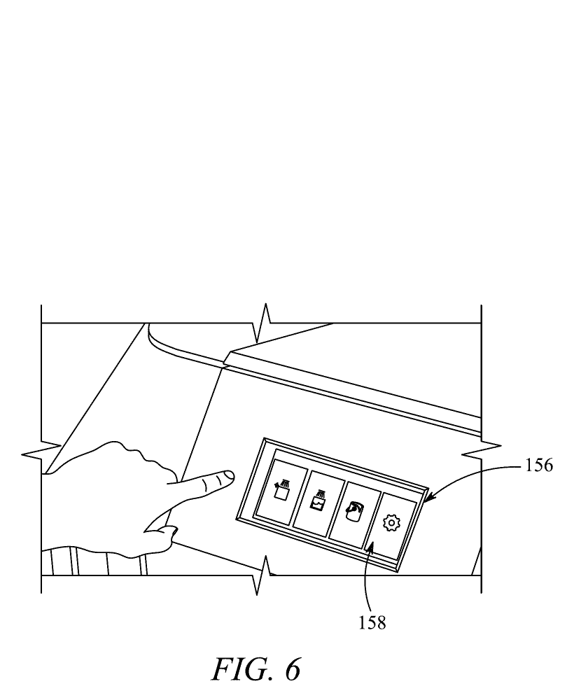

In an aspect of the present disclosure, the post processing machine 100 further includes a display 156 located on the top cover 108 of the housing 102. The display 156 is positioned for convenient user access and visibility, being integrated into the top cover 108 at an ergonomic viewing angle. FIG. 6 illustrates a detailed view of the display 156. As shown, the display 156 includes a digital screen, such as an LCD panel, that provides a graphical user interface for operator interaction with the post processing machine 100. The display 156 is connected to the microcontroller 154. The display 156 is electrically connected to the microcontroller 154 to receive display data and transmit user input signals. Herein, the display 156 is configured with a button interface 158 to receive inputs to perform the post processing. The button interface 158 is implemented as a touch-sensitive interface integrated with the display 156, presenting clearly labeled virtual buttons for various machine functions.

In an aspect of the present disclosure, the button interface 158 includes dedicated control sections for different processing operations, specifically presenting four main function buttons, including “Surface smoothing” for initiating and controlling primary surface treatment operations, “Painting” for accessing secondary color application functions, “Materials” for monitoring and managing processing material levels, and “Settings” for accessing machine configuration options. Each of these sections of the button interface 158 is displayed with an identifying icon and text label to clearly communicate its function to the operator of the post processing machine 100. The display 156 and the button interface 158 enable user selection of processing parameters, initiation of operations, and monitoring of process status. During operation, the display 156 provides real-time feedback including processing stage, remaining time, material levels, and any error or status messages. Further, the button interface 158 facilitates the operator to adjust processing parameters, select paint colors, initiate surface smoothing operations, and monitor progress through an intuitive menu system.

For this purpose, the button interface 158 may present a hierarchical menu structure with four primary control sections: surface smoothing, painting, materials, and settings. The surface smoothing section enables initiation of primary post processing, with options for starting scanning, choosing files, and monitoring completion status. The painting section provides controls for secondary post processing, including file selection, scanning initiation, and process monitoring. The materials section displays percentages of available processing materials within the paint cartridges 148, solvent tank 150, and water tank 152. The settings section incorporates multiple control functions including cleaning options (water, solvent, or combined cleaning cycles), connection management (Bluetooth and internet connectivity), manual controls (axis movement, light and camera operation), and system information access. The button interface 158 is configured to transmit all user inputs to the microcontroller 154 for executing corresponding control operations through the post processing machine 100.

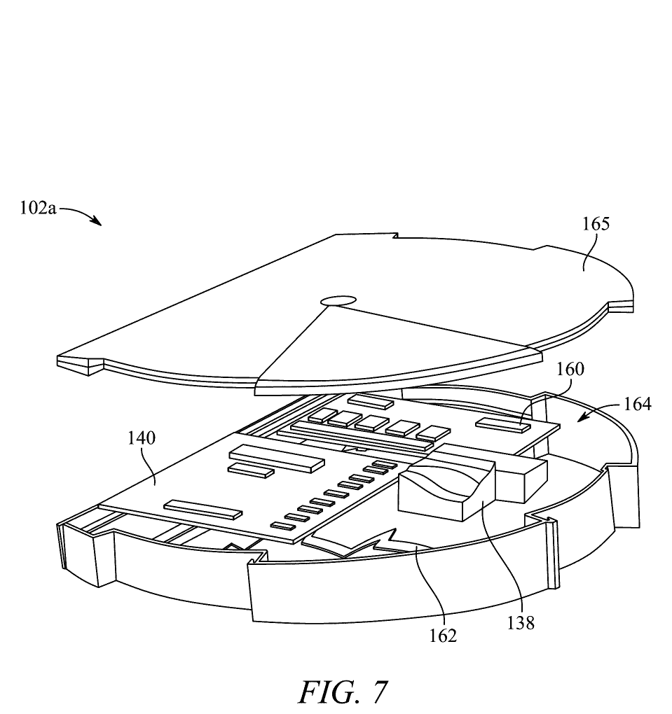

Referring to FIG. 7, illustrated is an exploded view of the first compartment 102a showing internal components arranged therein. As illustrated, the first compartment 102a includes a wireless communication unit 160 connected to the microcontroller 154. The wireless communication unit 160 enables remote communication between the post processing machine 100 and external computing devices, facilitating wireless transfer of processing parameters, object data, and operational status information. The wireless communication unit 160 supports standard wireless protocols for reliable data exchange with connected devices. The first compartment 102a also includes a power supply 162 connected to the microcontroller 154. The power supply 162 is configured to provide regulated electrical power to all electronic components of the post processing machine 100, including the microcontroller 154, the motor 138, the motion controller 140, various pumps 149, 151, 153, and the display 156. The power supply 162 incorporates protection circuits and power conditioning to ensure stable operation of all electrical systems.

Specifically, within the first compartment 102a, an electronics compartment 164 is configured to house and protect critical electrical and control components of the post processing machine 100. The electronics compartment 164 includes an electronics compartment cover 165 designed to shield the internal components from exposure to processing materials and environmental factors. The electronics compartment 164 is configured to house the motor 138, the motion controller 140, the microcontroller 154, the wireless communication unit 160, and the power supply 162, in a space-efficient arrangement while maintaining proper cooling and accessibility for maintenance. In present configurations, the electronics compartment cover 165 may incorporate seals and other protective features to prevent ingress of processing materials that may overflow or leak during operation, thereby protecting the sensitive electronic components housed within.

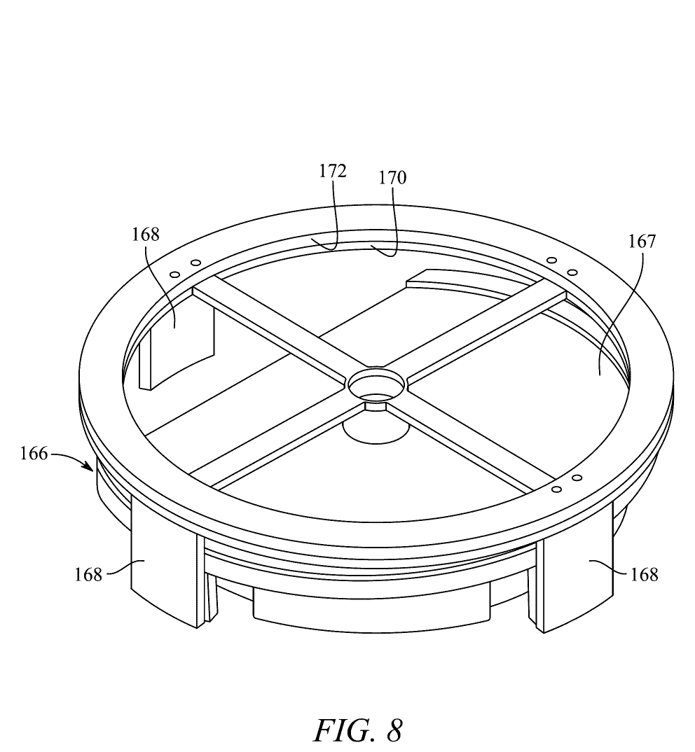

Further referring to FIGS. 1D and 8 in conjunction with each other, as shown, the post processing machine 100 includes an excess material holder 166 connected to the electronics compartment cover 165. Herein, the excess material holder 166 is configured to capture any one of water, solvent and paint which overflows from the first compartment 102a. Specifically, as shown, the excess material holder 166 is positioned above the electronics compartment 164 and is specifically configured to capture and contain overflow or excess processing materials including water, solvent, and paint that may drip or flow from the processing area during operation. Further, the electronics compartment cover 165 is configured to protect the motor 138, the motion controller 140, the microcontroller 154, and the power supply 162 from any one of water, solvent and paint which is not captured by the excess material holder. The electronics compartment cover 165 is specifically designed to work in conjunction with the excess material holder 166 to provide protection for the electronic components housed within the electronics compartment 164. This containment function prevents these materials from entering the electronics compartment 164 where sensitive components are housed.

Also, as illustrated, the excess material holder 166 includes a lid 167 that serves both containment and mechanical coupling functions. The lid 167 has a central shaft configured to mate with a central plug on a bottom side of the rotatable platform 120. Herein, the central shaft extends upward and is precisely configured to mate with the corresponding central plug formed on the bottom side of the rotatable platform 120. This mating arrangement ensures proper alignment and stable mechanical connection between the excess material holder 166 and the rotatable platform 120. Further, a plurality of legs 168 are connected to the lid 167 of the excess material holder 166. These legs 168 extend vertically from the lid 167 toward the rotatable platform 120, establishing a defined space between the excess material holder 166 and the rotatable platform 120 while maintaining structural stability. The legs 168 are uniformly distributed around the circumference of the lid 167, being evenly spaced to provide balanced support.

Referring further to FIGS. 1D and 8, as shown, the rotatable platform 120 includes a first ring 170 located on the lid 167 of the excess material holder 166. The first ring 170 provides a stable foundation for the rotating components of the post processing machine 100. The rotatable platform 120 also includes a second ring 172 located on the first ring 170. The second ring 172 includes a plurality of spokes, that provide structural support while minimizing weight. The second ring 172 further includes a central opening configured to receive the shaft of the lid 167 of the excess material holder 166. The plurality of legs 168 extending upward from the lid 167 are positioned to hold the first ring 170 and the second ring 172. The rotatable platform 120 further includes a circular base 174 located on the second ring 172. The circular base 174 is mechanically coupled and configured to rotate with the second ring 172. The circular base 174 provides the primary support surface for 3D printed objects during processing operations. When the motor 138 drives rotation through the mechanical coupling at the central shaft, the second ring 172 and the circular base 174 rotate together as an assembly, while the first ring 170 remains stationary, supported by the legs 168. This arrangement ensures stable support for objects during processing while facilitating proper distribution of mechanical loads through the post processing machine 100.

Herein, the circular base 174 is made of conductive metal. The conductive metal material may be selected for its electrical conductivity properties in addition to its structural characteristics. The conductive metal construction provides efficient transmission of electrostatic charges across the surface of the circular base 174. Further, the post processing machine 100 includes a negative ion generator 178 mounted on the bottom surface of the circular base 174. The negative ion generator 178 is electrically connected to the microcontroller 154 by wiring which is routed through one of the plurality of legs 168. The electrical connection between the negative ion generator 178 and the microcontroller 154 is established through wiring that is discretely routed through one of the plurality of legs 168. This routing path protects the electrical connections while maintaining functional integrity. The negative ion generator 178 is configured to generate static electricity which holds the 3D object on the circular base 174. In particular, the negative ion generator 178 is configured to produce negative ions that create an electrostatic charge on the conductive circular base 174. This electrostatic force effectively secures the 3D printed object to the circular base 174 during processing operations, preventing unwanted movement or displacement while allowing the object to be easily removed when processing is complete. The conductive metal construction of the circular base 174 ensures uniform distribution of the electrostatic charge across the entire support surface, providing consistent holding force regardless of position of the object on the rotatable platform 120.

In an aspect of the present disclosure, an interior of the first compartment 102a, an interior of the second compartment 102b, the semicircular wall 124, an interior of the excess material holder 166, the electronics compartment cover 165, the plurality of legs 168, the lid 167 of the excess material holder 166, the first ring 170, the second ring 172 and the circular base 174 are covered with an anti-graffiti coating. The anti-graffiti coating is applied as a protective surface treatment to multiple internal components and surfaces of the post processing machine 100. This specialized coating creates a non-stick, chemical-resistant barrier that prevents adhesion of processing materials including solvents, paints, and other substances used during post processing operations. In one or more examples, the anti-graffiti coating applied to the components of the post processing machine 100 is a permanent polyurethane-based coating selected for its barrier properties and high crosslinking density that reduces absorption of processing materials. This permanent coating creates a protective surface that prevents processing materials from bonding to the coated components, facilitating easy cleaning with simple solvents without damaging the underlying surfaces. The polyurethane-based coating is specifically chosen over other options like fluorinated or siloxane coatings due to its desired combination of chemical resistance, durability, cost effectiveness, and ease of application while maintaining sufficient protection against ethyl acetate solvent and various paints used in the post processing operations.

In present aspects, the microcontroller 154 is an integrated control system incorporating multiple components to manage all aspects of the post processing operations. Specifically, the microcontroller 154 includes electrical circuitry that provides interfaces and signal conditioning for communication with various sensors, actuators, and other electronic components of the post processing machine 100. The microcontroller 154 includes a memory module that stores program instructions defining operational sequences and control algorithms for post processing operations. The memory additionally stores reference data including a desired image shape representing target surface characteristics for the smoothing operations, and a desired painted image representing the intended final appearance after painting operations. These stored reference images serve as comparison standards for evaluating processing progress. One or more processors within the microcontroller 154 are configured to execute the stored program instructions to coordinate and control all processing operations. The processors implement control algorithms that manage the sequence and timing of processing steps, analyze feedback from the camera 144 and other sensors, and adjust operational parameters to achieve desired results.

The microcontroller 154 is configured to perform a first post processing step which smooths a surface of the 3D printed object by a generation of first processing signals which actuate the solvent pump 151 to spray solvent onto the 3D printed object while rotating the rotatable platform 120, actuate the water pump 153 to spray water onto the 3D printed object, actuate the camera 144 to take images of the 3D printed object, determine whether the images of the 3D printed object match a desired image shape stored in the memory of the microcontroller 154 and the continuation of the first post processing step until the images of the 3D printed object match the desired image shape. During this first post processing step, the microcontroller 154 coordinates multiple operations in a sequence. Initially, the microcontroller 154 generates control signals to activate the motor 138 through the motion controller 140, initiating rotation of the rotatable platform 120 at a predetermined speed. Simultaneously, the microcontroller 154 sends signals to the solvent pump 151 to begin spraying ethyl acetate solvent through designated spray nozzles 146 onto the rotating 3D printed object. Following the solvent application, the microcontroller 154 generates signals to activate the water pump 153, directing water spray through the nozzles 146 to remove excess solvent from surface of the object. Throughout this process, the microcontroller 154 sends signals to actuate the camera 144, which captures multiple images of the 3D printed object from different angles as it rotates on the rotatable platform 120. The processors of the microcontroller 154 analyze the captured images, comparing them against the desired image shape stored in memory. If the analysis indicates that the current surface characteristics do not match the desired image shape, the microcontroller 154 continues the processing cycle, generating additional signals to repeat the solvent and water spray sequences while maintaining rotation of the rotatable platform 120. This iterative process continues until the processed images indicate a match with the desired image shape stored in memory, at which point the first post processing step is completed.

The microcontroller 154 is further configured to perform a second post processing step which paints the 3D printed object with a selected paint color while rotating the rotatable platform 120 by a generation of second processing signals which include a selection of a spray nozzle 146, an actuation of the paint pump 149 to spray paint from the spray nozzle 146 of a desired color onto the 3D printed object, an actuation of the camera 144 to take images of the painted 3D printed object, a matching of the images of the painted 3D printed object to a desired painted image stored in the memory of the microcontroller 154 and a continuation of the second post processing step until the images of the 3D printed object match the desired painted image. During this second post processing step, the microcontroller 154 first identifies and selects the appropriate spray nozzle 146 corresponding to the desired paint color from among the plurality of spray nozzles 146 mounted on the crescent shaped nozzle band 142. The microcontroller 154 then generates control signals to the motion controller 140 to initiate rotation of the rotatable platform 120 at a speed optimized for paint application. The microcontroller 154 generates signals to activate the corresponding paint pump 149 of the selected paint cartridge 148, controlling the delivery of paint through the selected spray nozzle 146 onto the rotating object. Throughout the painting process, the microcontroller 154 actuates the camera 144 to capture sequential images of the painted surface from multiple angles as the object rotates. The processors of the microcontroller 154 analyze these captured images in real-time, comparing the current painted surface characteristics against the desired painted image stored in memory. When differences are detected between the current state and the desired painted image, the microcontroller 154 continues generating signals to maintain paint application through the selected nozzle 146. The painting process continues iteratively until the analysis confirms that the captured images match the desired painted image specifications stored in memory, indicating successful completion of the second post processing step.

Further, the processor of the microcontroller 154 is configured to execute the program instructions to transform the images of the 3D printed object into a 3D mesh. During post processing operations, the processor executes specialized image processing algorithms to convert the multiple images captured by the camera 144 into a three-dimensional digital mesh representation of the object. This transformation process combines image data from multiple angles to construct a complete 3D mesh model that accurately represents the current physical state of the object being processed. The processor is further configured to execute the program instructions to perform the post processing until the 3D mesh aligns with the image of the desired painted image of the 3D object. For this purpose, the processor continuously updates this 3D mesh model as new images are captured during processing. The updated mesh is computationally aligned with the desired painted image stored in memory to evaluate processing progress. This alignment process involves comparing geometric features, surface characteristics, and color properties between the current 3D mesh and the desired reference image to identify areas requiring additional processing. The processor is further configured to execute the program instructions to display the 3D mesh on the display 156 with the desired painted image of the 3D object. This side-by-side visualization enables operators to monitor processing progress in real-time. The display 156 shows the evolving 3D mesh, updating as new images are captured and transformed, alongside the target painted image for reference. This visual feedback helps operators understand the current state of processing and verify whether proper processing is taking place to achieve the desired final appearance.

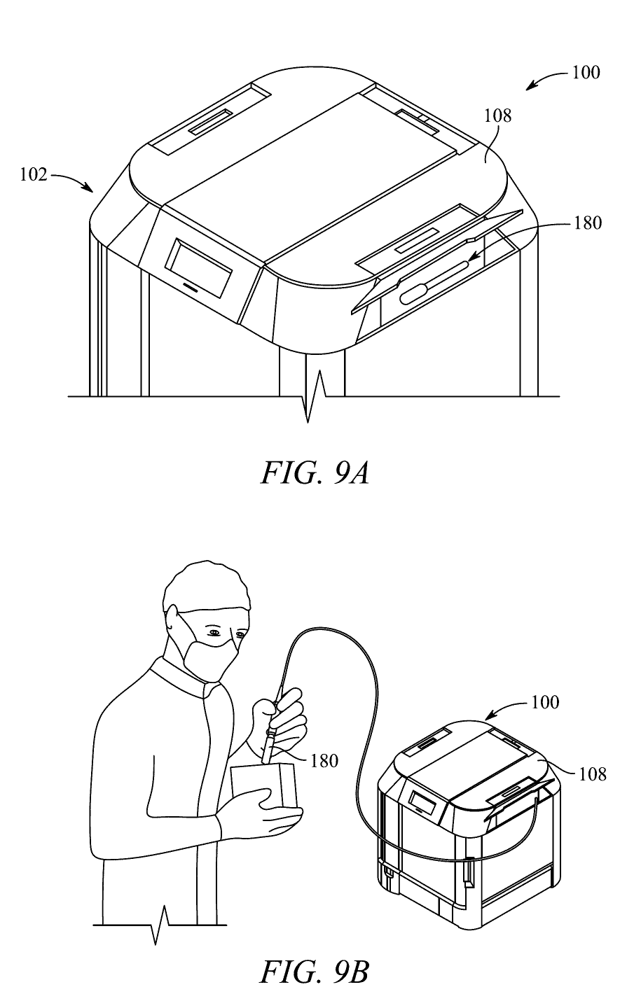

Referring now to FIGS. 9A and 9B, as illustrated, the post processing machine 100 may also include a finishing tool 180 integrated into its structure. FIG. 9A illustrates the finishing tool 180 in its mounted configuration within the post processing machine 100. As illustrated, the finishing tool 180 is integrated into the housing 102 (such as, in the top cover 108) in a manner that maintains accessibility while ensuring secure storage when not in use. Further, as illustrated in FIG. 9B, the finishing tool 180 is configured to enable manual post-processing operations when desired by an operator. An operator, as shown, can remove the finishing tool 180 from its integrated storage position and use it to perform targeted surface finishing operations on specific areas of the processed 3D printed object. The finishing tool 180 may incorporate a handle for comfortable grip and precise control during manual operation. A flexible connection element extends from the finishing tool 180 to the main housing 102, ensuring continuous supply of processing materials and/or electric power during manual operation. This configuration allows operators to perform detailed finishing work on specific areas of the processed 3D printed object, as may be desired, to achieve optimal surface finishing results.

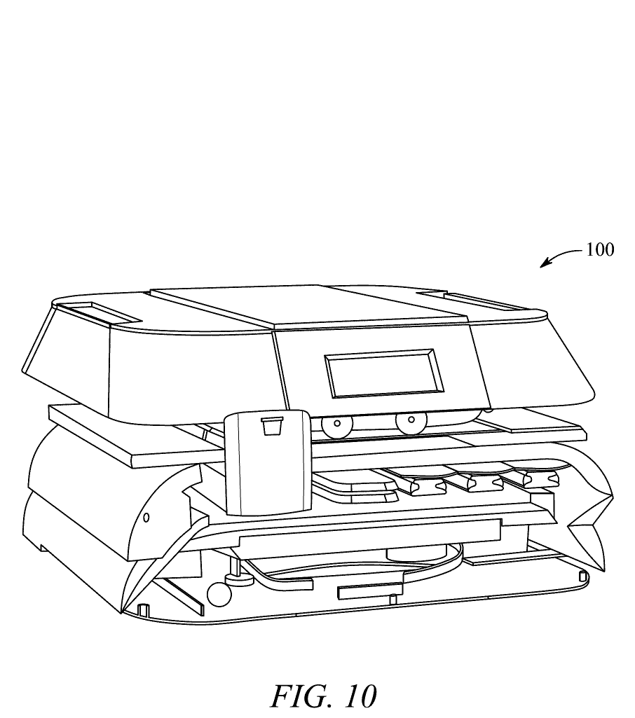

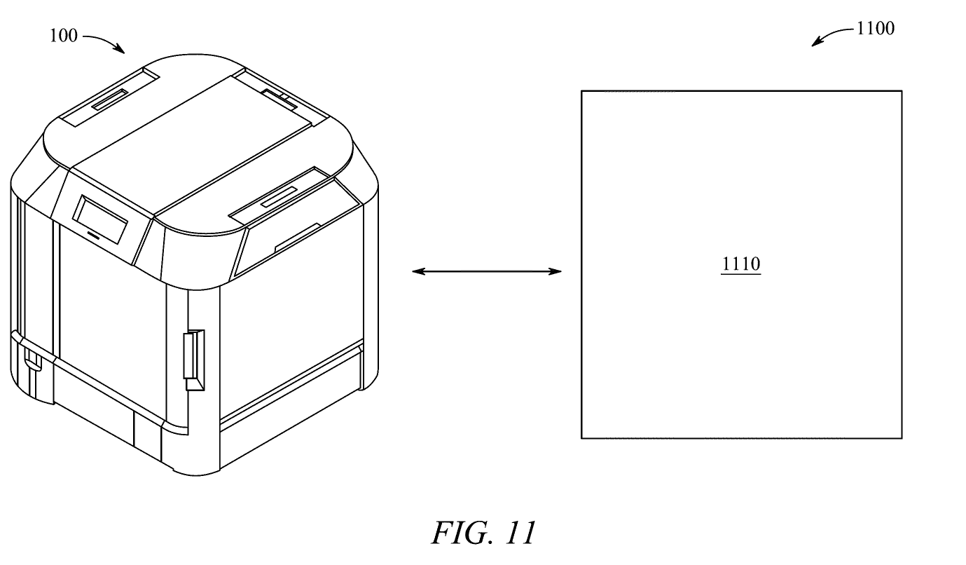

Referring to FIG. 10, the post processing machine 100 is illustrated in a collapsed configuration suitable for packaging and transport. In the collapsed configuration, the components of the post processing machine 100 are arranged in a compact, layered arrangement that minimizes the overall volume and footprint while protecting sensitive components. The collapsed configuration maintains the base structural elements including the bottom cover 110 as a foundation, upon which other components are systematically arranged. The various components are positioned in predetermined locations that optimize space utilization while preventing contact between sensitive components. Such collapsed configuration facilitates the post processing machine 100 to be efficiently packaged for shipping and similar purposes, while ensuring all components remain properly protected and aligned for subsequent reassembly at the point of use.

The post processing machine 100 implements a streamlined operational sequence that significantly reduces processing time compared to manual methods. The complete processing cycle begins when a 3D printed object requiring surface finishing is placed on the rotatable platform 120. Initially, an operator inputs processing parameters through the display 156 and positions the object within the inner chamber 104, a step requiring approximately 20 minutes including initial setup and alignment procedures. The primary post processing phase, controlled by the microcontroller 154, executes automated surface smoothing operations requiring approximately 3 minutes. During this phase, the microcontroller 154 coordinates solvent application through the spray nozzles 146, water rinsing, and continuous monitoring through the camera 144 to achieve desired surface characteristics. Following successful completion of surface smoothing, the operator can initiate the secondary post processing phase for color application, which proceeds automatically for approximately 15 minutes. During this autonomous operation, the operator is free to perform other tasks while the post processing machine 100 executes the painting sequence and allows for proper drying time. This automated approach significantly reduces the total processing time to approximately 38 minutes, compared to traditional manual methods which typically require several hours. It is estimated that the post processing machine 100 may take about one-third time (or less) compared to traditional manual methods. Moreover, the consistent, computer-controlled processing ensures uniform quality results across multiple objects, eliminating variations that commonly occur with manual finishing techniques.

The post processing machine 100 of the present disclosure incorporates specific materials selected for their functional properties and manufacturability. The transparent covers for the side walls 116, 118 and the hermetically sealable door 106 are fabricated from clear acrylic sheet, chosen instead of glass for improved safety, longevity, and reduced weight, and are manufactured using laser cutting processes with anti-graffiti coating applied as a finishing treatment. Various components including the top cover 108, the bottom cover 110, the excess material holder 166, the electronics compartment cover 165, are constructed from HDPE (High-Density Polyethylene) plastic, selected for strength, durability, and recyclability, and are formed through injection molding with metallic finish electroplating. Components exposed to processing fluids, including the base supporting the rotatable platform 120 and excess material storage components, are manufactured from stainless steel using metal stamping processes to ensure corrosion resistance. The cylindrical chamber 122 and materials cartridge mechanisms are fabricated from stainless steel using deep-draw stamping techniques. The venting wall 126 is produced through metal stamping, while components for excess material storage utilize iron formed through expanding processes. The post processing machine 100 also incorporates several ready-made components including the display 156, the motion controller 140, the motor 138, the camera 144, USB reader, filtration components (HEPA filter 132, carbon filter 134, prefilter 136), threaded rods, and lighting elements.

In various aspects, the post processing machine 100 is dimensioned to accommodate objects commonly produced by consumer-grade 3D printers. The housing 102 has overall dimensions of approximately 350 millimeters (mm) in width, 380 mm in length, and 400 mm in height (H). The inner chamber 104 provides an effective processing space of approximately 220 mm by 220 mm by 250 mm. The rotatable platform 120 has a diameter of approximately 200 mm and is positioned at a height of H/5 (approximately 80 mm) from the bottom cover 110. The cylindrical chamber 122 within the second compartment 102b has an internal diameter of approximately 240 mm, with the crescent shaped nozzle band 142 following this curvature. The hermetically sealable door 106 has dimensions of approximately 300 mm in height and 280 mm in width to provide adequate access to the inner chamber 104. The display 156 integrated into the top cover 108 measures approximately 120 mm by 80 mm. These dimensions are selected to maintain a compact form factor suitable for desktop placement while ensuring sufficient capacity for processing typical consumer-scale 3D printed objects.

For maintenance and cleaning operations, the post processing machine 100 includes specific features to facilitate removal of accumulated materials. The excess material holder 166 can be configured as a drawer that can be pulled outward from the housing 102 for access. The excess material holder 166 includes separate compartments for solid and liquid waste materials. The solid materials can be removed from an upper compartment while liquid materials can be drained from a lower compartment. All interior surfaces of the excess material holder 166 and other components exposed to processing materials are treated with anti-graffiti coating to prevent material adhesion and simplify cleaning. The microcontroller 154 may also incorporate programmed cleaning sequences that can be initiated through the display 156. An operator can select specific cleaning operations from the settings menu, which activate predetermined sequences of water or solvent spraying through the spray nozzles 146 to clean interior surfaces. After completion of the automated cleaning sequence, any remaining residue can be easily wiped away with a cloth due to the anti-graffiti coating. The coating prevents strong adhesion of materials, enabling complete removal of processing residues with minimal effort while maintaining the integrity of interior surfaces.

Referring now to FIG. 11, illustrated is a schematic diagram of a system 1100 for operating the post processing machine 100 to post process 3D printed objects. The system 1100 includes the post processing machine 100, with its structural and operational components being same as previously described, including the housing 102 having the inner chamber 104 and the hermetically sealable door 106; the rotatable platform 120 within the housing 102 for holding 3D printed objects; the motor 138 and motion controller 140 for controlled platform rotation; the plurality of spray nozzles 146; and the camera 144 for object imaging. The system 1100 includes the microcontroller 154 connected to the operational components including the motor 138, the motion controller 140, the solvent pump 151, the water pump 153, the plurality of paint pumps 149, and the camera 144. The microcontroller 154 incorporates electrical circuitry, memory storing processing instructions and reference images, and processors executing these instructions to perform the surface smoothing and painting operations as previously described.

Herein, the system 1100 incorporates a post processing computer application executed on a remote computing device 1110. The post processing computer application is configured to receive image data captured by the camera 144 during both the surface smoothing and painting operations. Specifically, the post processing computer application receives images of the 3D printed object during initial processing and subsequent images of the painted 3D printed object during color application steps. The post processing computer application executes image processing algorithms that transform the received 2D images into 3D mesh representations of the object. This transformation is performed for both the initial surface condition images and the painted surface images, creating detailed digital models that represent current state of the object at each processing stage. The post processing computer application, stored on the remote computing device 1110, also maintains a database of desired 3D images that serve as reference standards for the processing operations. The post processing computer application performs real-time comparison and matching operations between the generated 3D mesh representations and these stored reference images. This matching process evaluates multiple characteristics including surface geometry, texture, and color properties to determine processing progress and completion status.

The system 1100 implements bidirectional wireless communication between the post processing machine and the remote computing device 1110. The wireless communication unit 160 of the post processing machine establishes and maintains this wireless connection, enabling real-time data exchange during processing operations. When the post processing computer application completes its analysis and mesh generation, it transmits the resulting 3D mesh data back to the wireless communication unit 160. The wireless communication unit 160 is configured to receive these 3D mesh transmissions from the remote computing device 1110 and transmit the 3D mesh to the memory of the microcontroller 154. This data transfer enables the microcontroller 154 to use the most current and accurate 3D representations for controlling and adjusting the processing operations. The wireless communication capabilities support various standard wireless protocols to ensure reliable and secure data exchange. This distributed processing architecture, combining local control through the microcontroller 154 with advanced image processing on the remote computing device 1110, leverages computational resources of the remote computing device 1110 for complex mesh generation and analysis tasks, while the microcontroller 154 is utilized for real-time control of processing operations.

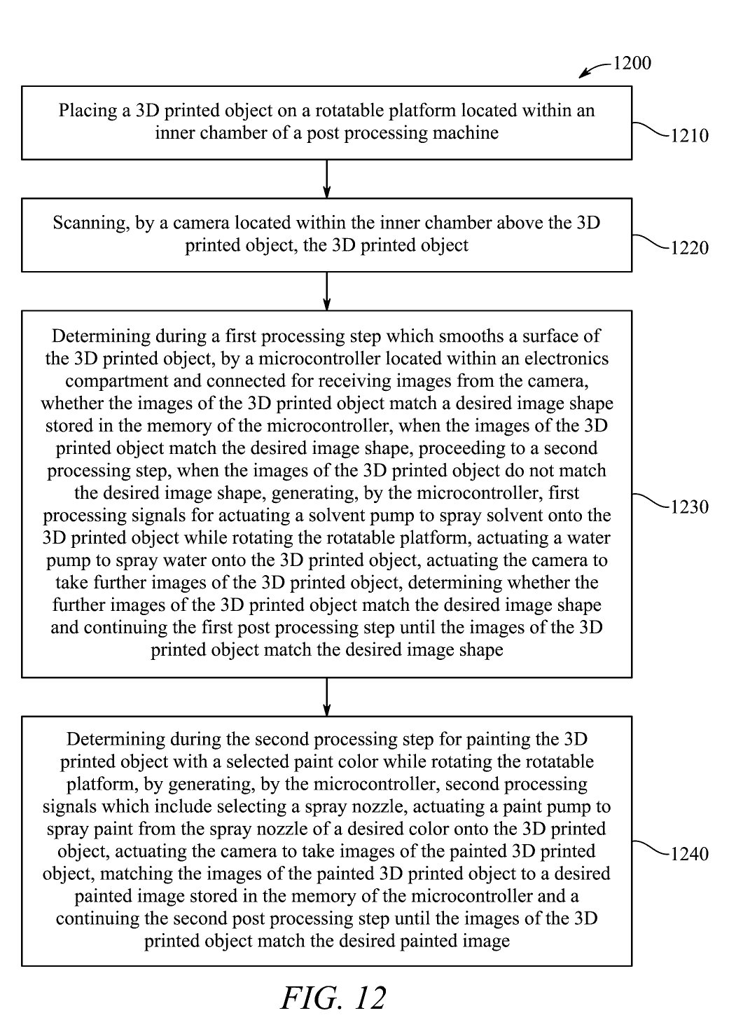

Referring now to FIG. 12, the present disclosure further provides a method (as represented by a flowchart, referred by reference numeral 1200) for post processing a 3D printed object. The method 1200 includes a series of steps. These steps are only illustrative, and other alternatives may be considered where one or more steps are added, one or more steps are removed, or one or more steps are provided in a different sequence without departing from the scope of the present disclosure. Various variants disclosed above, with respect to the aforementioned post processing machine 100 apply mutatis mutandis to the present method 1200. The method 1200 enables systematic processing of 3D printed objects to achieve desired surface characteristics and appearance.

At step 1210, the method 1200 includes placing the 3D printed object on the rotatable platform 120 located within the inner chamber 104 of the post processing machine 100. The placement operation involves opening the hermetically sealable door 106 to access the inner chamber 104, positioning the 3D printed object on the circular base 174 of the rotatable platform 120, and ensuring proper centering of the object. The static electricity generated by the negative ion generator 178 helps secure the object to the circular base 174 during this placement step.

At step 1220, the method 1200 includes scanning, by the camera 144 located within the inner chamber 104 above the 3D printed object, the 3D printed object. The camera 144, mounted on the crescent shaped nozzle band 142, initiates a scanning sequence of the placed object. During scanning, the microcontroller 154 coordinates with the motion controller 140 to rotate the rotatable platform 120 through the motor 138, enabling the camera 144 to capture images of the object from multiple angles. These images are captured to gather data regarding the initial surface condition and geometry of the 3D printed object.

At step 1230, the method 1200 includes determining during the first processing step which smooths a surface of the 3D printed object, by the microcontroller 154 located within the electronics compartment 164 and connected for receiving images from the camera 144, whether the images of the 3D printed object match a desired image shape stored in the memory of the microcontroller 154. When the images of the 3D printed object match the desired image shape, the method 1200 proceeds to a second processing step. However, when the images of the 3D printed object do not match the desired image shape, the microcontroller 154 executes a sequence of processing operations. Specifically, the microcontroller 154 generates first processing signals that initiate multiple coordinated actions, including actuating the solvent pump 151 to spray the solvent through the spray nozzles 146 onto the 3D printed object while simultaneously controlling the motor 138 through the motion controller 140 to rotate the rotatable platform 120; actuating the water pump 153 to spray water through the spray nozzles 146 onto the 3D printed object to remove excess solvent; and actuating the camera 144 to capture additional images of the processed object. The microcontroller 154 continuously analyzes these further images, comparing them against the desired image shape stored in its memory. This comparison evaluates surface characteristics including smoothness, uniformity, and dimensional accuracy. The first post processing step continues iteratively, with the microcontroller 154 generating additional processing signals for solvent application, water spraying, and image capture until the analyzed images indicate a match with the desired image shape stored in memory. Throughout this step, the fan 128 and the filtration system comprising the HEPA filter 132, the carbon filter 134, and the prefilter 136 operate to remove processing vapors and maintain air quality within the inner chamber 104. The excess material holder 166 captures any overflow of solvent or water for proper containment.

In an aspect, the method 1200 further includes controlling, by the motion controller 140 connected to the microcontroller 154, a speed of the rotor of the motor 138 connected to the rotatable platform 120. The motion controller 140 receives digital control signals from the microcontroller 154 and generates corresponding electrical drive signals to regulate the rotational speed of the motor 138. This speed control ensures optimal rotation rates for different processing operations, with speeds being adjusted based on the specific requirements of surface smoothing or painting operations being performed. The method 1200 also includes actuating, by the microcontroller 154, any one of the water pump 153, the solvent pump 151 and the paint pump 149. The microcontroller 154 generates specific actuation signals to control the operation of these pumps individually or in coordinated sequences. When actuating the solvent pump 151, the microcontroller 154 controls the delivery of ethyl acetate from the solvent tank 150 through the spray nozzles 146. For water application, the microcontroller 154 activates the water pump 153 to deliver water from the water tank 152. During painting operations, the microcontroller 154 selectively actuates specific paint pumps 149 corresponding to desired paint colors from the paint cartridges 148.

At step 1240, the method 1200 includes determining during the second processing step for painting the 3D printed object with a selected paint color while rotating the rotatable platform 120. This determination is made by the microcontroller 154 generating second processing signals which coordinate multiple painting operations in sequence. Initially, the second processing signals include selecting a specific spray nozzle from the plurality of spray nozzles 146 mounted on the crescent shaped nozzle band 142, where each nozzle corresponds to a particular paint color. The microcontroller 154 then actuates the corresponding paint pump 149 connected to the selected spray nozzle 146 through dedicated tubing from the respective paint cartridge 148. This actuation controls the spray of paint of the desired color onto the 3D printed object while the motion controller 140 maintains rotation of the rotatable platform 120 through the motor 138. During the painting process, the microcontroller 154 actuates the camera 144 to capture sequential images of the painted 3D printed object from multiple angles. These captured images are continuously matched against a desired painted image stored in the memory of the microcontroller 154. The second post processing step continues iteratively, with the microcontroller 154 maintaining platform rotation and paint application while repeatedly capturing and analyzing images. This iterative process continues until the analyzed images of the painted object match the specifications of the desired painted image stored in memory, indicating successful completion of the painting operation.

The method 1200 further includes transforming, by the processor of the microcontroller 154, the images of the 3D printed object captured by the camera 144 into a 3D mesh. This transformation process involves analyzing multiple images captured from different angles as the rotatable platform 120 rotates, and converting the two-dimensional image data into a three-dimensional digital mesh representation that accurately depicts the current state of the object being processed. The method 1200 includes performing the second post processing until the 3D mesh aligns with the image of the desired painted image of the 3D object. During this alignment process, the processor continuously updates the 3D mesh model as new images are captured by the camera 144. The processor compares the current 3D mesh against the desired painted image stored in memory, evaluating geometric features, surface characteristics, and color properties to identify areas requiring additional paint application through the selected spray nozzle 146. The method 1200 further includes displaying the 3D mesh on the display 156 with the desired painted image of the 3D object. The microcontroller 154 generates display signals to present both the current 3D mesh and the desired painted image simultaneously on the display 156. This visualization facilitates operators to monitor the progress of the painting operation in real-time and to verify whether proper processing is taking place to achieve the desired final appearance.

The method 1200 further includes communicating, by a communication unit (such as, the wireless communication unit 160) connected to the microcontroller 154, with a computing device (such as, the remote computing device 1110) configured with a post processing computer application. The post processing computer application is specifically configured for receiving two sets of images during processing operations: the initial images of the 3D printed object captured during surface smoothing, and the subsequent images of the painted 3D printed object captured during color application. The method 1200 includes transforming each set of received images into 3D mesh representations through processing algorithms executed on the remote computing device 1110. The post processing computer application performs this transformation separately for both the surface condition images and the painted surface images, creating detailed digital models representing state of the object at each processing stage. The method 1200 also includes matching the generated 3D mesh with a desired 3D image stored in the database of the post processing computer application. This matching process evaluates multiple characteristics including surface geometry, texture uniformity, and color properties to determine processing progress and completion status. The application maintains a library of reference 3D images against which mesh of the current object is compared. The method 1200 includes transmitting the analyzed 3D mesh data from the remote computing device 1110 to the wireless communication unit 160. This transmission occurs over established wireless protocols that ensure secure and reliable data transfer between the remote computing device 1110 and the post processing machine 100. The method 1200 further includes transmitting, by the wireless communication unit 160, the received 3D mesh data to the memory of the microcontroller 154. This local storage of the mesh data enables the microcontroller 154 to use the most current and accurate 3D representations for controlling and adjusting ongoing processing operations.

The post processing machine 100, the system 1100 and the method 1200 of the present disclosure provide an approach to automated finishing of 3D printed objects by integrating both surface smoothing and painting capabilities within a single controlled environment. The post processing machine 100 combines computer vision through the camera 144, precise fluid delivery through coordinated spray nozzles 146, and real-time process monitoring through 3D mesh generation and comparison. This provides the ability to autonomously execute both primary surface smoothing and secondary painting operations while maintaining continuous quality verification through image analysis and mesh comparison. Further, in the system 1100, the integration of the wireless communication unit 160 with the remote computing device 1110, executing specialized post processing computer applications, provides analysis and control capabilities beyond local processing limitations.

A first embodiment describes a post processing machine 100 for 3D printed objects, comprising: a housing 102 having an inner chamber 104 and a hermetically sealable door 106; a rotatable platform 120 located within the housing 102, wherein the rotatable platform 120 is configured to hold a 3D printed object; a motor 138 configured to rotate the rotatable platform 120; a motion controller 140 configured to control the rotation of the motor 138; a plurality of spray nozzles 146; a camera 144 directed to take images of the 3D printed object by scanning the 3D printed object; a microcontroller 154 connected to the motor 138, the motion controller 140, a solvent pump 151, a water pump 153, a plurality of paint pumps 149 and the camera 144, wherein the microcontroller 154 includes electrical circuitry, a memory storing program instructions for post processing, a desired image shape and a desired painted image, and one or more processors configured to execute the program instructions to: perform a first post processing step which smooths a surface of the 3D printed object by a generation of first processing signals which actuate the solvent pump 151 to spray solvent onto the 3D printed object while rotating the rotatable platform 120, actuate the water pump 153 to spray water onto the 3D printed object, actuate the camera 144 to take images of the 3D printed object, determine whether the images of the 3D printed object match a desired image shape stored in the memory of the microcontroller 154 and the continuation of the first post processing step until the images of the 3D printed object match the desired image shape and perform a second post processing step which paints the 3D printed object with a selected paint color while rotating the rotatable platform 120 by a generation of second processing signals which include a selection of a spray nozzle 146, an actuation of the paint pump 149 to spray paint from the spray nozzle 146 of a desired color onto the 3D printed object, an actuation of the camera 144 to take images of the painted 3D printed object, a matching of the images of the painted 3D printed object to a desired painted image stored in the memory of the microcontroller 154 and a continuation of the second post processing step until the images of the 3D printed object match the desired painted image.

In an aspect, the post processing machine 100 further comprises a crescent shaped nozzle band 142 located on an inner surface of the cylindrical chamber 122, wherein the crescent shaped nozzle band 142 is configured to hold the camera 144 and the plurality of spray nozzles 146.

In an aspect, the post processing machine 100 further comprises a plurality of paint cartridges 148, wherein each paint cartridge 148 includes a paint pump 149 connected by tubing to a dedicated one of the spray nozzles 146 of the plurality of spray nozzles 146; a solvent tank 150 connected by a solvent pump 151 to the plurality of spray nozzles 146 of the crescent shaped nozzle band 142; and a water tank 152 connected by a water pump 153 to the plurality of spray nozzles 146 of the crescent shaped nozzle band 142.

In an aspect, the post processing machine 100 further comprises a display 156 located on the top cover 108 of the housing 102, wherein the display 156 is connected to the microcontroller 154, wherein the display 156 is configured with a button interface 158 to receive inputs to perform the post processing.

In an aspect, the processor of the microcontroller 154 is further configured to execute the program instructions to: transform the images of the 3D printed object into a 3D mesh; perform the post processing until the 3D mesh aligns with the image of the desired painted image of the 3D object; and display the 3D mesh on the display 156 with the desired painted image of the 3D object.

In an aspect, the solvent is ethyl acetate.

In an aspect, the housing 102 comprises: a top cover 108, a bottom cover 110, a front wall 112, a back wall 114 opposite the front wall 112, a first side wall 116 and a second side wall 118 opposite to the first side wall 116, wherein a distance between the top cover 108 and the bottom cover 110 is equal to a height H, and wherein the hermetically sealable door 106 is located in the front wall 112; a first compartment 102a located between the bottom cover 110 and the rotatable platform 120, wherein a distance from the bottom cover 110 to the rotatable platform 120 is about H/5, wherein the rotatable platform 120 is parallel to the bottom cover 110; a second compartment 102b located between the rotatable platform 120 and the top cover 108, wherein a distance from the rotatable platform 120 to the top cover 108 is about 4H/5; and a cylindrical chamber 122 located within the second compartment 102b, wherein a central length axis of the cylindrical chamber 122 is concentric with a central length axis of the rectangular housing 102, wherein the cylindrical chamber 122 includes a semicircular wall 124 adjacent to the back wall 114 and partially adjacent to the first side wall 116 and the second side wall 118.

In an aspect, the post processing machine 100 further comprises a venting wall 126 adjacent to the back wall 114; a fan 128 adjacent the venting wall 126, wherein the fan 128 includes a frame 130; a HEPA filter 132 located within the frame 130 adjacent to the fan 128; a carbon filter 134 located within the frame 130 adjacent to the HEPA filter 132; and a prefilter 136 located within the frame 130 adjacent to the carbon filter 134.

In an aspect, the first compartment 102a comprises: a wireless communication unit 160 connected to the microcontroller 154; a power supply 162 connected to the microcontroller 154; and an electronics compartment 164 configured to house the motor 138, the motion controller 140, the microcontroller 154, the wireless communication unit 160 and the power supply 162, wherein the electronics compartment 164 includes an electronics compartment cover 165.

In an aspect, the motor 138 comprises: a stator connected to the bottom cover 110, wherein the stator is configured with a core; and a rotor located within the core, wherein the rotor is configured to rotate the rotatable platform 120, wherein the motion controller 140 is configured to control a speed of the motor 138.

In an aspect, the post processing machine 100 further comprises an excess material holder 166 connected to the electronics compartment cover 165, wherein the excess material holder 166 is configured to capture any one of water, solvent and paint which overflows from the first compartment 102a, wherein the electronics compartment cover 165 is configured to protect the motor 138, the motion controller 140, the microcontroller 154 and the power supply 162 from any one of water, solvent and paint which is not captured by the excess material holder 166, wherein the excess material holder 166 includes a lid 167 having a central shaft configured to mate with a central plug on a bottom side of the rotatable platform 120; and a plurality of legs 168 connected to the lid 167 of the excess material holder 166, wherein the legs 168 extend from the lid 167 towards the rotatable platform 120, wherein the plurality of legs 168 are evenly spaced about the lid 167.

In an aspect, the rotatable platform 120 comprises: a first ring 170 located on the lid 167 of the excess material holder 166; a second ring 172 located on the first ring 170, wherein the second ring 172 includes a plurality of spokes and a central opening configured to receive the shaft of the lid 167 of the excess material holder 166, wherein the plurality of legs 168 are configured to hold the first ring 170 and the second ring 172; and a circular base 174 located on the second ring 172, wherein the circular base 174 is configured to rotate with the second ring 172, wherein the circular base 174 is made of conductive metal.

In an aspect, the post processing machine 100 further comprises a negative ion generator 178 located on a bottom surface of the circular base 174, wherein the negative ion generator 178 is electrically connected to the microcontroller 154 by wiring which is routed through one of the plurality of legs 168, wherein the negative ion generator 178 is configured to generate static electricity which holds the 3D object on the circular base 174.

In an aspect, an interior of the first compartment 102a, an interior of the second compartment 102b, the semicircular wall 124, an interior of the excess material holder 166, the electronics compartment cover 165, the plurality of legs 168, the lid 167 of the excess material holder 166, the first ring 170, the second ring 172 and the circular base 174 are covered with an anti-graffiti coating.

In an aspect, the microcontroller 154 is configured to communicate with a remote computing device 1110 configured with a post processing computer application, wherein the post processing computer application is configured to receive the images of 3D printed object and the images of the images of the painted 3D printed object during the post processing, transform each of the images of 3D printed object and the images of the images of the painted 3D printed object to the 3D mesh, match the 3D mesh with a desired 3D image stored in the post processing computer application and transmit the 3D mesh to the wireless communication unit 160, wherein the wireless communication unit 160 is configured to transmit the 3D mesh to the memory of the microcontroller 154.

A second embodiment describes a method 1200 for post processing a 3D printed object, comprising: placing a 3D printed object on a rotatable platform 120 located within an inner chamber 104 of a post processing machine 100; scanning, by a camera 144 located within the inner chamber 104 above the 3D printed object, the 3D printed object; determining during a first processing step which smooths a surface of the 3D printed object, by a microcontroller 154 located within an electronics compartment 164 and connected for receiving images from the camera 144, whether the images of the 3D printed object match a desired image shape stored in the memory of the microcontroller 154, when the images of the 3D printed object match the desired image shape, proceeding to a second processing step, when the images of the 3D printed object do not match the desired image shape, generating, by the microcontroller 154, first processing signals for actuating a solvent pump 151 to spray solvent onto the 3D printed object while rotating the rotatable platform 120, actuating a water pump 153 to spray water onto the 3D printed object, actuating the camera 144 to take further images of the 3D printed object, determining whether the further images of the 3D printed object match the desired image shape and continuing the first post processing step until the images of the 3D printed object match the desired image shape; then determining during the second processing step for painting the 3D printed object with a selected paint color while rotating the rotatable platform 120, by generating, by the microcontroller 154, second processing signals which include selecting a spray nozzle 146, actuating a paint pump 149 to spray paint from the spray nozzle 146 of a desired color onto the 3D printed object, actuating the camera 144 to take images of the painted 3D printed object, matching the images of the painted 3D printed object to a desired painted image stored in the memory of the microcontroller 154 and a continuing the second post processing step until the images of the 3D printed object match the desired painted image.

In an aspect, the method 1200 further comprises transforming, by the processor of the microcontroller 154, the images of the 3D printed object into a 3D mesh; performing the second post processing until the 3D mesh aligns with the image of the desired painted image of the 3D object; and displaying the 3D mesh on a display 156 with the desired painted image of the 3D object.

In an aspect, the method 1200 further comprises communicating, by a wireless communication unit 160 connected to the microcontroller 154, with a remote computing device 1110 configured with a post processing computer application, wherein the post processing computer application is configured for receiving the images of 3D printed object and the images of the images of the painted 3D printed object during the post processing; transforming each of the images of 3D printed object and the images of the images of the painted 3D printed object to a 3D mesh; matching the 3D mesh with a desired 3D image stored in the post processing computer application; transmitting the 3D mesh to the wireless communication unit 160; and transmitting, by the wireless communication unit 160, the 3D mesh to the memory of the microcontroller 154.

In an aspect, the method 1200 further comprises controlling, by a motion controller 140 connected to the microcontroller 154, a speed of a rotor of a motor 138 connected to the rotatable platform 120; actuating, by the microcontroller 154, any one of the water pump 153, the solvent pump 151 and the paint pump 149.

A third embodiment describes a system 1100 for operating a post processing machine 100 to post process 3D printed objects, comprising: a housing 102 having an inner chamber 104 and a hermetically sealable door 106; a rotatable platform 120 located within the housing 102, wherein the rotatable platform 120 is configured to hold a 3D printed object; a motor 138 configured to rotate the rotatable platform 120; a motion controller 140 configured to control the rotation of the motor 138; a plurality of spray nozzles 146; a camera 144 directed to take images of the 3D printed object by scanning the 3D printed object; a microcontroller 154 connected to the motor 138, the motion controller 140, a solvent pump 151, a water pump 153, a plurality of paint pumps 149 and the camera 144, wherein the microcontroller 154 includes electrical circuitry, a memory storing program instructions for post processing, a desired image shape and a desired painted image, and one or more processors configured to execute the program instructions to: perform a first post processing step which smooths a surface of the 3D printed object by a generation of first processing signals which actuate the solvent pump 151 to spray solvent onto the 3D printed object while rotating the rotatable platform 120, actuate the water pump 153 to spray water onto the 3D printed object, actuate the camera 144 to take images of the 3D printed object, determine whether the images of the 3D printed object match a desired image shape stored in the memory of the microcontroller 154 and the continuation of the first post processing step until the images of the 3D printed object match the desired image shape; perform a second post processing step which paints the 3D printed object with a selected paint color while rotating the rotatable platform 120 by a generation of second processing signals which include a selection of a spray nozzle 146, an actuation of the paint pump 149 to spray paint from the spray nozzle 146 of a desired color onto the 3D printed object, an actuation of the camera 144 to take images of the painted 3D printed object, a matching of the images of the painted 3D printed object to a desired painted image stored in the memory of the microcontroller 154 and a continuation of the second post processing step until the images of the 3D printed object match the desired painted image; and a post processing computer application stored on a remote computing device 1110 configured to receive the images of 3D printed object and the images of the images of the painted 3D printed object during the post processing, transform each of the images of 3D printed object and the images of the images of the painted 3D printed object to the 3D mesh, match the 3D mesh with a desired 3D image stored in the post processing computer application and transmit the 3D mesh to the wireless communication unit 160, wherein the wireless communication unit 160 is configured to transmit the 3D mesh to the memory of the microcontroller 154.

Next, further details of the hardware description of a computing environment according to exemplary embodiments is described with reference to FIG. 13. In FIG. 13, a controller 1300 is described is representative of the microcontroller 154 of the post processing machine 100 as well as the remote computing device 1110 of the system 1100, in which the controller 1300 is a computing device which includes a CPU 1301 which performs the processes described above/below. The process data and instructions may be stored in memory 1302. These processes and instructions may also be stored on a storage medium disk 1304 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1301, 1303 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1301 or CPU 1303 may be a Xenon or Core processor from Intel of America or an Opteron processor from AMD of America, or may be other processor types that would be recognized by one of ordinary skill in the art. Alternatively, the CPU 1301, 1303 may be implemented on an FPGA, ASIC, PLD or using discrete logic circuits, as one of ordinary skill in the art would recognize. Further, CPU 1301, 1303 may be implemented as multiple processors cooperatively working in parallel to perform the instructions of the inventive processes described above.

The computing device in FIG. 13 also includes a network controller 1306, such as an Intel Ethernet PRO network interface card from Intel Corporation of America, for interfacing with network 1360. As can be appreciated, the network 1360 can be a public network, such as the Internet, or a private network such as an LAN or WAN network, or any combination thereof and can also include PSTN or ISDN sub-networks. The network 1360 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1308, such as a NVIDIA GeForce GTX or Quadro graphics adaptor from NVIDIA Corporation of America for interfacing with display 1310, such as a Hewlett Packard HPL2445w LCD monitor. A general purpose I/O interface 1312 interfaces with a keyboard and/or mouse 1314 as well as a touch screen panel 1316 on or separate from display 1310. General purpose I/O interface also connects to a variety of peripherals 1318 including printers and scanners, such as an OfficeJet or DeskJet from Hewlett Packard.

A sound controller 1320 is also provided in the computing device such as Sound Blaster X-Fi Titanium from Creative, to interface with speakers/microphone 1322 thereby providing sounds and/or music.

The general purpose storage controller 1324 connects the storage medium disk 1304 with communication bus 1326, which may be an ISA, EISA, VESA, PCI, or similar, for interconnecting all of the components of the computing device. A description of the general features and functionality of the display 1310, keyboard and/or mouse 1314, as well as the display controller 1308, storage controller 1324, network controller 1306, sound controller 1320, and general purpose I/O interface 1312 is omitted herein for brevity as these features are known.

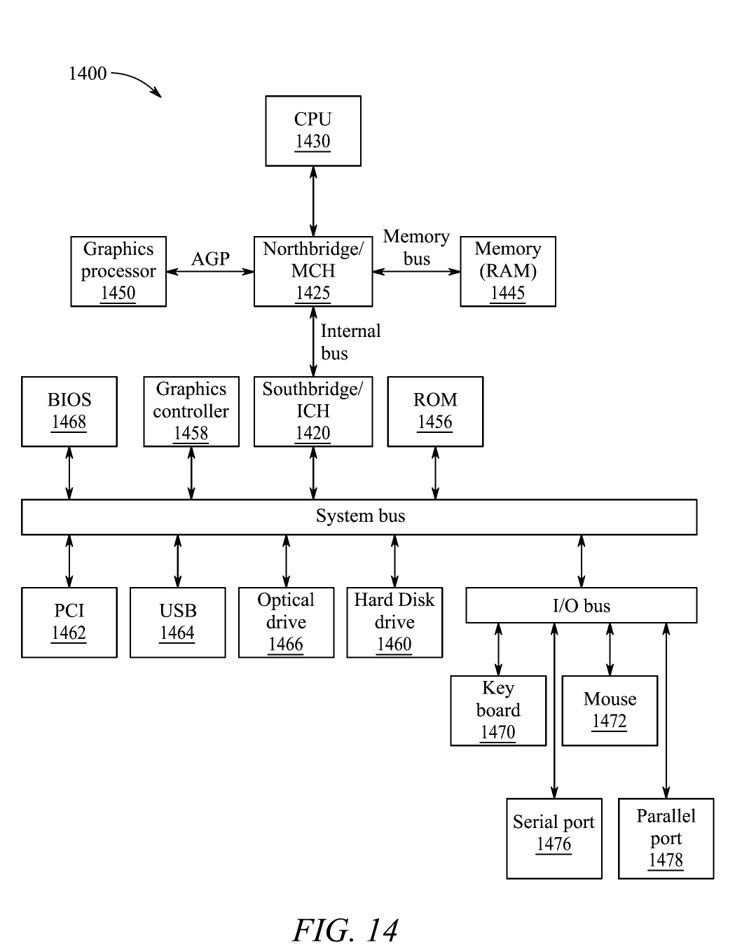

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 14.

FIG. 14 shows a schematic diagram of a data processing system, according to certain embodiments, for performing the functions of the exemplary embodiments. The data processing system is an example of a computer in which code or instructions implementing the processes of the illustrative embodiments may be located.

In FIG. 14, data processing system 1400 employs a hub architecture including a north bridge and memory controller hub (NB/MCH) 1425 and a south bridge and input/output (I/O) controller hub (SB/ICH) 1420. The central processing unit (CPU) 1430 is connected to NB/MCH 1425. The NB/MCH 1425 also connects to the memory 1445 via a memory bus, and connects to the graphics processor 1450 via an accelerated graphics port (AGP). The NB/MCH 1425 also connects to the SB/ICH 1420 via an internal bus (e.g., a unified media interface or a direct media interface). The CPU Processing unit 1430 may contain one or more processors and even may be implemented using one or more heterogeneous processor systems.

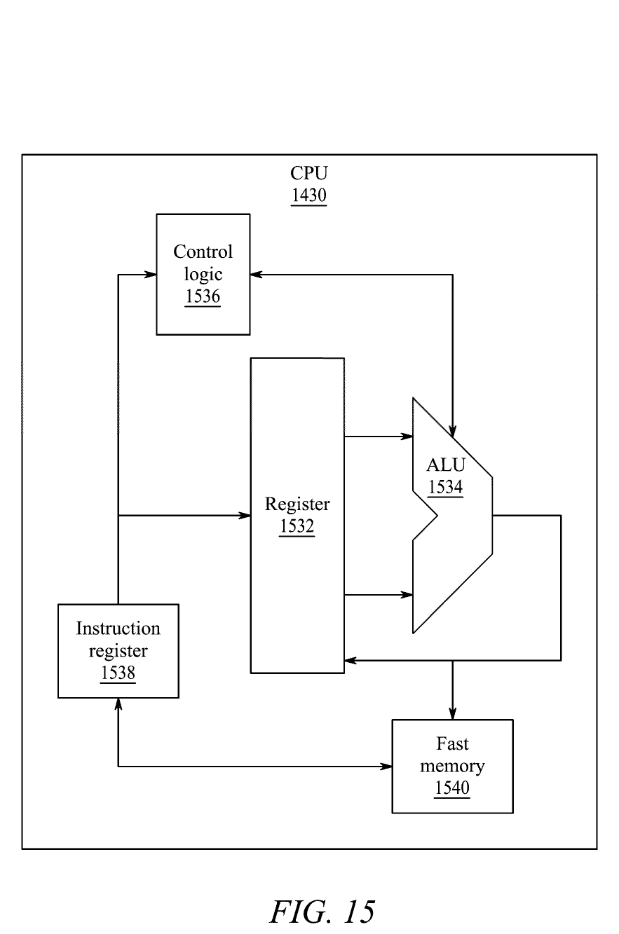

For example, FIG. 15 shows one implementation of CPU 1430. In one implementation, the instruction register 1538 retrieves instructions from the fast memory 1540. At least part of these instructions are fetched from the instruction register 1538 by the control logic 1536 and interpreted according to the instruction set architecture of the CPU 1430. Part of the instructions can also be directed to the register 1532. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1534 that loads values from the register 1532 and performs logical and mathematical operations on the loaded values according to the instructions. The results from these operations can be feedback into the register and/or stored in the fast memory 1540. According to certain implementations, the instruction set architecture of the CPU 1430 can use a reduced instruction set architecture, a complex instruction set architecture, a vector processor architecture, a very large instruction word architecture. Furthermore, the CPU 1430 can be based on the Von Neuman model or the Harvard model. The CPU 1430 can be a digital signal processor, an FPGA, an ASIC, a PLA, a PLD, or a CPLD. Further, the CPU 1430 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 14, the data processing system 1400 can include that the SB/ICH 1420 is coupled through a system bus to an I/O Bus, a read only memory (ROM) 1456, universal serial bus (USB) port 1464, a flash binary input/output system (BIOS) 1468, and a graphics controller 1458. PCI/PCIe devices can also be coupled to SB/ICH 1488 through a PCI bus 1462.

The PCI devices may include, for example, Ethernet adapters, add-in cards, and PC cards for notebook computers. The Hard disk drive 1460 and CD-ROM 1466 can use, for example, an integrated drive electronics (IDE) or serial advanced technology attachment (SATA) interface. In one implementation the I/O bus can include a super I/O (SIO) device.

Further, the hard disk drive (HDD) 1460 and optical drive 1466 can also be coupled to the SB/ICH 1420 through a system bus. In one implementation, a keyboard 1470, a mouse 1472, a parallel port 1478, and a serial port 1476 can be connected to the system bus through the I/O bus. Other peripherals and devices that can be connected to the SB/ICH 1420 using a mass storage controller such as SATA or PATA , an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

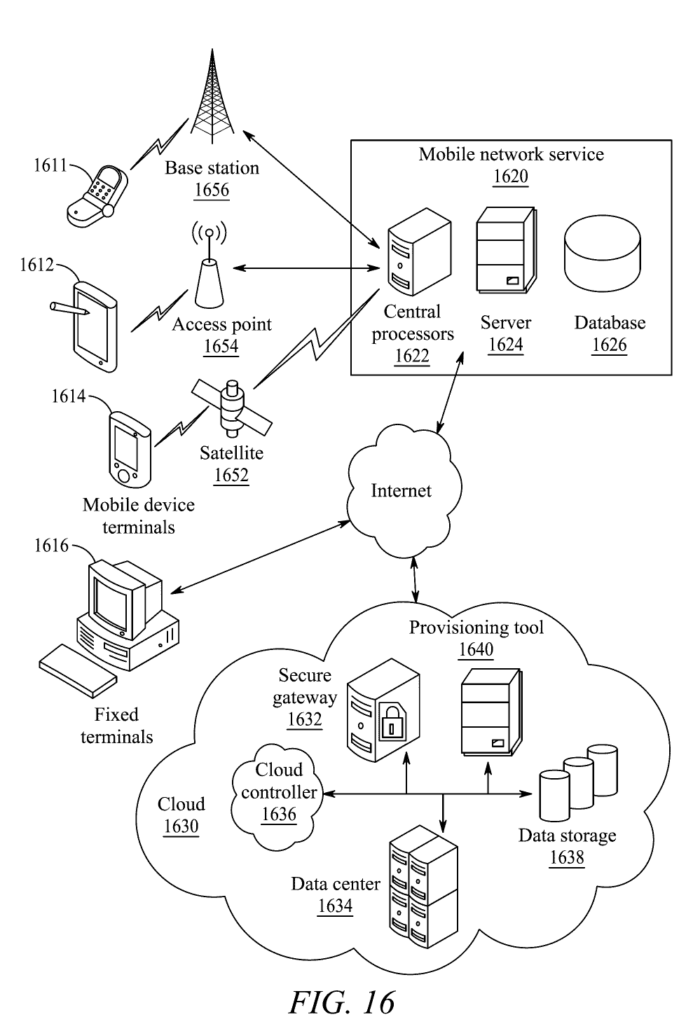

The functions and features described herein may also be executed by various distributed components of a system. For example, one or more processors may execute these system functions, wherein the processors are distributed across multiple components communicating in a network. The distributed components may include one or more client and server machines, such as cloud 1630 including a cloud controller 1636, a secure gateway 1632, a data center 1634, data storage 1638 and a provisioning tool 1640, and mobile network services 1620 including central processors 1622, a server 1624 and a database 1626, which may share processing, as shown by FIG. 16, in addition to various human interface and communication devices (e.g., display monitors 1616, smart phones 1610, tablets 1612, personal digital assistants (PDAs) 1614). The network may be a private network, such as a LAN, satellite 1652 or WAN 1654, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

While specific embodiments of the invention have been described, it should be understood that various modifications and alternatives may be implemented without departing from the spirit and scope of the invention. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A post processing machine for 3D printed objects, comprising:
a housing having an inner chamber and a hermetically sealable door;
a rotatable platform located within the housing, wherein the rotatable platform is configured to hold a 3D printed object;
a motor configured to rotate the rotatable platform;
a motion controller configured to control the rotation of the motor;
a plurality of spray nozzles;
a camera directed to take images of the 3D printed object by scanning the 3D printed object;
a microcontroller connected to the motor, the motion controller, a solvent pump, a water pump, a plurality of paint pumps and the camera, wherein the microcontroller includes electrical circuitry, a memory storing program instructions for post processing, a desired image shape and a desired painted image, and one or more processors configured to execute the program instructions to:
perform a first post processing step which smooths a surface of the 3D printed object by a generation of first processing signals which actuate the solvent pump to spray solvent onto the 3D printed object while rotating the rotatable platform, actuate the water pump to spray water onto the 3D printed object, actuate the camera to take images of the 3D printed object, determine whether the images of the 3D printed object match a desired image shape stored in the memory of the microcontroller and the continuation of the first post processing step until the images of the 3D printed object match the desired image shape; and
perform a second post processing step which paints the 3D printed object with a selected paint color while rotating the rotatable platform by a generation of second processing signals which include a selection of a spray nozzle, an actuation of the paint pump to spray paint from the spray nozzle of a desired color onto the 3D printed object, an actuation of the camera to take images of the painted 3D printed object, a matching of the images of the painted 3D printed object to a desired painted image stored in the memory of the microcontroller and a continuation of the second post processing step until the images of the 3D printed object match the desired painted image.

2. The post processing machine of claim 1, further comprising:
a crescent shaped nozzle band located on an inner surface of the cylindrical chamber, wherein the crescent shaped nozzle band is configured to hold the camera and the plurality of spray nozzles.

3. The post processing machine of claim 2, further comprising:
a plurality of paint cartridges, wherein each paint cartridge includes a paint pump connected by tubing to a dedicated one of the spray nozzles of the plurality of spray nozzles;
a solvent tank connected by a solvent pump to the plurality of spray nozzles of the crescent shaped nozzle band; and
a water tank connected by a water pump to the plurality of spray nozzles of the crescent shaped nozzle band.

4. The post processing machine of claim 1, further comprising:
a display located on the top cover of the housing, wherein the display is connected to the microcontroller, wherein the display is configured with a button interface to receive inputs to perform the post processing.

5. The post processing machine of claim 4, wherein the processor is further configured to execute the program instructions to:
transform the images of the 3D printed object into a 3D mesh;
perform the post processing until the 3D mesh aligns with the image of the desired painted image of the 3D object; and
display the 3D mesh on the display with the desired painted image of the 3D object.

6. The post processing machine of claim 1, wherein the solvent is ethyl acetate.

7. The post processing machine of claim 1, wherein the housing comprises:
a top cover, a bottom cover, a front wall, a back wall opposite the front wall, a first side wall and a second side wall opposite to the first side wall, wherein a distance between the top cover and the bottom cover is equal to a height H, and wherein the hermetically sealable door is located in the front wall;
a first compartment located between the bottom cover and the rotatable platform, wherein a distance from the bottom cover to the rotatable platform is about H/5, wherein the rotatable platform is parallel to the bottom cover;
a second compartment located between the rotatable platform and the top cover, wherein a distance from the rotatable platform to the top cover is about 4H/5; and
a cylindrical chamber located within the second compartment, wherein a central length axis of the cylindrical chamber is concentric with a central length axis of the rectangular housing, wherein the cylindrical chamber includes a semicircular wall adjacent to the back wall and partially adjacent to the first side wall and the second side wall.

8. The post processing machine of claim 7, further comprising:
a venting wall adjacent to the back wall;
a fan adjacent the venting wall, wherein the fan includes a frame;
a HEPA filter located within the frame adjacent to the fan;
a carbon filter located within the frame adjacent to the HEPA filter; and
a prefilter located within the frame adjacent to the carbon filter.

9. The post processing machine of claim 7, wherein the first compartment comprises:
a wireless communication unit connected to the microcontroller;
a power supply connected to the microcontroller; and
an electronics compartment configured to house the motor, the motion controller, the microcontroller, the wireless communication unit and the power supply, wherein the electronics compartment includes an electronics compartment cover.

10. The post processing machine of claim 9, wherein the motor comprises:
a stator connected to the bottom cover, wherein the stator is configured with a core; and
a rotor located within the core, wherein the rotor is configured to rotate the rotatable platform,
wherein the motion controller is configured to control a speed of the motor.

11. The post processing machine of claim 9, further comprising:
an excess material holder connected to the electronics compartment cover, wherein the excess material holder is configured to capture any one of water, solvent and paint which overflows from the first compartment, wherein the electronics compartment cover is configured to protect the motor, the motion controller, the microcontroller and the power supply from any one of water, solvent and paint which is not captured by the excess material holder, wherein the excess material holder includes a lid having a central shaft configured to mate with a central plug on a bottom side of the rotatable platform; and
a plurality of legs connected to the lid of the excess material holder, wherein the legs extend from the lid towards the rotatable platform, wherein the plurality of legs are evenly spaced about the lid.

12. The post processing machine of claim 11, wherein the rotatable platform comprises:
a first ring located on the lid of the excess material holder;
a second ring located on the first ring, wherein the second ring includes a plurality of spokes and a central opening configured to receive the shaft of the lid of the excess material holder, wherein the plurality of legs are configured to hold the first ring and the second ring; and
a circular base located on the second ring, wherein the circular base is configured to rotate with the second ring, wherein the circular base is made of conductive metal.

13. The post processing machine of claim 12, further comprising:
a negative ion generator located on a bottom surface of the circular base, wherein the negative ion generator is electrically connected to the microcontroller by wiring which is routed through one of the plurality of legs, wherein the negative ion generator is configured to generate static electricity which holds the 3D object on the circular base.

14. The post processing machine of claim 12, wherein an interior of the first compartment, an interior of the second compartment, the semicircular wall, an interior of the excess material holder, the electronics compartment cover, the plurality of legs, the lid of the excess material cover, the first ring, the second ring and the circular base are covered with an anti-graffiti coating.

15. The post processing machine of claim 9, wherein the microcontroller is configured to communicate with a computing device configured with a post processing computer application, wherein the post processing computer application is configured to receive the images of 3D printed object and the images of the images of the painted 3D printed object during the post processing, transform each of the images of 3D printed object and the images of the images of the painted 3D printed object to the 3D mesh, match the 3D mesh with a desired 3D image stored in the post processing computer application and transmit the 3D mesh to the wireless communication unit,
wherein the wireless communication unit is configured to transmit the 3D mesh to the memory of the microcontroller.

16. A method for post processing a 3D printed object, comprising:
placing a 3D printed object on a rotatable platform located within an inner chamber of a post processing machine;
scanning, by a camera located within the inner chamber above the 3D printed object, the 3D printed object;
determining during a first processing step which smooths a surface of the 3D printed object, by a microcontroller located within an electronics compartment and connected for receiving images from the camera, whether the images of the 3D printed object match a desired image shape stored in the memory of the microcontroller,
when the images of the 3D printed object match the desired image shape, proceeding to a second processing step,
when the images of the 3D printed object do not match the desired image shape, generating, by the microcontroller, first processing signals for actuating a solvent pump to spray solvent onto the 3D printed object while rotating the rotatable platform, actuating a water pump to spray water onto the 3D printed object, actuating the camera to take further images of the 3D printed object, determining whether the further images of the 3D printed object match the desired image shape and continuing the first post processing step until the images of the 3D printed object match the desired image shape; then
determining during the second processing step for painting the 3D printed object with a selected paint color while rotating the rotatable platform, by generating, by the microcontroller, second processing signals which include selecting a spray nozzle, actuating a paint pump to spray paint from the spray nozzle of a desired color onto the 3D printed object, actuating the camera to take images of the painted 3D printed object, matching the images of the painted 3D printed object to a desired painted image stored in the memory of the microcontroller and a continuing the second post processing step until the images of the 3D printed object match the desired painted image.

17. The method of claim 16, further comprising:
transforming, by the processor, the images of the 3D printed object into a 3D mesh;
performing the second post processing until the 3D mesh aligns with the image of the desired painted image of the 3D object; and
displaying the 3D mesh on a display with the desired painted image of the 3D object.

18. The method of claim 16, further comprising:
communicating, by a communication unit connected to the microcontroller, with a computing device configured with a post processing computer application, wherein the post processing computer application is configured for receiving the images of 3D printed object and the images of the images of the painted 3D printed object during the post processing;
transforming each of the images of 3D printed object and the images of the images of the painted 3D printed object to a 3D mesh;
matching the 3D mesh with a desired 3D image stored in the post processing computer application;
transmitting the 3D mesh to the wireless communication unit; and
transmitting, wireless communication unit, the 3D mesh to the memory of the microcontroller.

19. The method of claim 16, further comprising:
controlling, by a motion controller connected to the microcontroller, a speed of a rotor of a motor connected to the rotatable platform;
actuating, by the microcontroller, any one of the water pump, the solvent pump and the paint pump.

20. A system for operating a post processing machine to post process 3D printed objects, comprising:
a housing having an inner chamber and a hermetically sealable door;
a rotatable platform located within the housing, wherein the rotatable platform is configured to hold a 3D printed object;
a motor configured to rotate the rotatable platform;
a motion controller configured to control the rotation of the motor;
a plurality of spray nozzles;
a camera directed to take images of the 3D printed object by scanning the 3D printed object;
a microcontroller connected to the motor, the motion controller, a solvent pump, a water pump, a plurality of paint pumps and the camera, wherein the microcontroller includes electrical circuitry, a memory storing program instructions for post processing, a desired image shape and a desired painted image, and one or more processors configured to execute the program instructions to:
perform a first post processing step which smooths a surface of the 3D printed object by a generation of first processing signals which actuate the solvent pump to spray solvent onto the 3D printed object while rotating the rotatable platform, actuate the water pump to spray water onto the 3D printed object, actuate the camera to take images of the 3D printed object, determine whether the images of the 3D printed object match a desired image shape stored in the memory of the microcontroller and the continuation of the first post processing step until the images of the 3D printed object match the desired image shape;
perform a second post processing step which paints the 3D printed object with a selected paint color while rotating the rotatable platform by a generation of second processing signals which include a selection of a spray nozzle, an actuation of the paint pump to spray paint from the spray nozzle of a desired color onto the 3D printed object, an actuation of the camera to take images of the painted 3D printed object, a matching of the images of the painted 3D printed object to a desired painted image stored in the memory of the microcontroller and a continuation of the second post processing step until the images of the 3D printed object match the desired painted image; and
a post processing computer application stored on a remote computing device configured to receive the images of 3D printed object and the images of the images of the painted 3D printed object during the post processing, transform each of the images of 3D printed object and the images of the images of the painted 3D printed object to the 3D mesh, match the 3D mesh with a desired 3D image stored in the post processing computer application and transmit the 3D mesh to the wireless communication unit,
wherein the wireless communication unit is configured to transmit the 3D mesh to the memory of the microcontroller.
